(19) United States
(12) Patent Application Publication
(10) Pub. No.: US 2018/0285805 A1
(43) Pub. Date: Oct. 4, 2018

(54) SYSTEM AND METHOD FOR PROVIDING QUALIFIED VALUATIONS OF TANGIBLE PERSONAL PROPERTY

(71) Applicant: Morgan Brittney Rigaud, Cincinnati, OH (US)

(72) Inventor: Morgan Brittney Rigaud, Cincinnati, OH (US)

(21) Appl. No.: 15/928,463

(22) Filed: Mar. 22, 2018

Related U.S. Application Data
(60) Provisional application No. 62/481,169, filed on Apr. 4, 2017.

(51) Int. Cl. G06Q 10/06; G06Q 30/02

(52) U.S. Cl. CPC G06Q 10/063118; G06Q 30/0278; G06Q 10/063112

(57) ABSTRACT

A method of valuating an item for a client including the steps of (a) identifying the item-category of the item; (b) identifying the valuation-purpose based on the client's needs; (c) assigning an appraiser from a community of appraisers and (d) valuating the item using an automated valuation method for said valuation-purpose. The various appraisers are not required to personally visit and examine the items. The appraiser is qualified to valuate the item for the item-category and valuation-purpose. The appraiser may be represented by two or more individual appraisers so as to competently appraise the item for item-category and valuation-purpose. The assigning of an appraiser may be performed by a project coordinator. The identification of the item may be performed by an inventory specialist. The identification of item-category may include a plurality of items. The plurality of items may be grouped within a collection by a catalog specialist. The identification of the valuation-purpose may be performed by an inventory specialist. The identification of valuation-purpose may include a plurality of items. It may be desirable to assign an appropriate number of appraisers for the underlying valuation-purpose. It may be desirable to validate a plurality of valuations by comparing them to each other. A valuation report may be created for the client.

### FIELD OF THE INVENTION

This invention relates to a system and method for providing qualified valuations of tangible personal property (e.g., painting, books, jewelry). More specifically, this invention relates to a system and method for providing qualified valuations of tangible personal property wherein the tangible personal property is categorized into a particular item-category and then the valuation is performed by an appraiser who has been pre-qualified. The system provides a score to assess the performance of multiple appraisers. Said scores may be used to govern the overall performance of the appraisers such that the system is continually improved upon.

### BACKGROUND OF THE INVENTION

Today, when an individual wants to get an item of tangible personal property (hereinafter, “TPP”) appraised they will often search the Internet for similar items across a variety of marketplaces (e.g. Amazon, eBay, Craigslist). This approach is flawed in that these websites are often cluttered with a huge range of semi-related items and often sold at prices that are not truly reflective of an educated marketplace. Another possible means of getting an appraisal is engaging with auction companies (eg, Sotheby's); however, these companies enjoy significant negotiation leverage over the individual and thus charges substantial fees. Further, these companies might have an incentive to provide inaccurate valuation since they are also interested in buying or selling said objects. Yet another possible means of getting an appraisal is engaging with a professional appraiser; however, it's often unclear the true credentials and qualifications of the appraiser and whether they are truly a specialist for that particular category of TPP.

And while it's important to identify the right source/appraiser for obtaining a proper appraisal, it's also important to understand the underlying client need for seeking an appraisal (i.e., valuation-purpose). It is this combination of item-category and valuation-purpose that is at the core of the failings of the current marketplace. Accordingly, in a first example, an individual has a famous Van Gogh painting and wants to get it appraised for insurance purposes. An appraisal for insurance seeks to identify the cost of replacing the painting with a similar item having Likeness-Kind-Quality (LKQ) within a reasonable period of time. For a famous Van Gogh painting, it may require several years before such a replacement painting is made available for purchase on the open market. Further, such a rare painting may only be available for purchase within a limited, exclusive network. Since insurance seeks to replace the painting within a reasonable time, the insurance appraisal value may be set at a higher price (referred to as Retail Replacement Value, RRV) in order to buy such a replacement painting within a reasonable time from an exclusive marketplace.

In a second example, the same individual having a famous Van Gogh painting wants to get it appraised for estate planning purposes. An appraisal for estate settlement and tax planning purposes seeks to identify the price for buying/selling the same item wherein the transaction includes a willing buyer, willing seller, both parties having knowledge of the facts, and neither party is compelled to buy/sell (referred to as Fair Market Value, FMV). It's important to note that Fair Market Value is most often less expensive than Retail Replacement Value. Accordingly, if an individual obtains a RRV-appraisal for estate settlement and tax planning purposes (which actually recommends FMV), then she would be paying more taxes than required. In yet another example, if an individual is seeking a divorce, then he would want to get an MCV-appraisal (marketable cash value) as it is equal to FMV minus marketing and selling fees.

Lastly, for a large estate having a multitude of items, the full duration of conducting all the appraisals may take several months. Today, these appraisals are normally conducted in a non-coordinated manner and without any synergistic benefits among multiple appraisers.

What is needed is a system and method for providing qualified valuations of tangible personal property wherein the TPP is categorized into a particular item-category, the valuation-purpose is known and the valuation is performed by pre-qualified appraisers for each objects' category and purpose.

What is needed is a system and method that assigns valuation assignments to various pre-qualified appraisers based on the objects' category, the valuation purpose and the time availability of individual appraisers.

What is further needed is a system that provides a score to assess the performance of multiple appraisers. Said scores may be used to govern the overall performance of the appraisers such that the system is continually improved upon.

### SUMMARY OF THE INVENTION

A method of valuating an item for a client including the steps of (a) identifying the item-category of the item; (b) identifying the valuation-purpose based on the client's needs; (c) assigning an appraiser from a community of appraisers and (d) valuating the item using the right valuation method for said valuation-purpose. The appraiser is qualified to value the item based on the item-category and valuation-purpose. The appraiser may be completed by two or more individual appraisers so as to competently appraise the item according to the item-category and valuation-purpose. The assigning of an appraiser may be performed by a project coordinator. The identifying of the item may be performed by an inventory specialist. The identifying of item-category may include a plurality of items. The plurality of items may be grouped within a collection by a catalog specialist. The identifying of the valuation-purpose may be performed by an inventory specialist. The identifying of valuation-purpose may include a plurality of items. It may be desirable to assign an appropriate number of appraisers for the underlying valuation-purpose. It may be desirable to validate a plurality of valuations by comparing them to each other. A valuation report may be created for the client.

A method of valuating a plurality of items using a networked-community, including the steps of (a) assigning a first item for valuation to a first appraiser of an appraisal community, said appraisal community having a plurality of appraisers and (b) assigning a second item for valuation to a second appraiser of said appraisal community, wherein the first item and second items are part of a collection and thus the collection is valuated faster by leveraging a plurality of appraisers with a networked-community. The assigning of first item and second item may be performed by a Project Coordinator. The first appraiser and second appraiser may collaborate to create a synergistic effect resulting in a better valuation. It may be desirable to re-assign the first item to a third appraiser of an appraisal community to ensure a timely and competent valuation of the first item.

A method of creating and self-validating a community of appraisers, including the steps of (a) pre-qualifying appraisers for item-categories and valuation-purposes, (b) assessing the performance of said appraisers and (c) modifying the appraiser networked-community membership based on their performance. The assessing of appraisers may be performed by their peers within the networked-community. The modification of the appraiser networked-community may be performed by a managing director.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. None of the drawings are necessarily to scale. These drawings are meant to be exemplary and not meant to be limiting of the present invention.

FIG. 1 is an exemplary collection of tangible personal property (TPP);

FIG. 2 is an exemplary table showing the needs of a client for valuating a collection of TPP;

FIG. 3 is an exemplary table showing the corresponding valuation purposes, appraisal approaches, valuation types and appropriate market places;

FIG. 4 is an exemplary table showing items from a collection being assigned to appraisers and their respective qualifications for specific item-categories, valuation purposes and availability of the appraisers;

FIG. 5 is an exemplary table showing items from a collection being assigned to an individual appraiser;

FIG. 6a is an exemplary table showing an item from a collection being assigned to a plurality of appraisers;

FIG. 6b is an exemplary table showing items from a collection being valuated by a plurality of appraisers;

FIG. 7 is an exemplary table showing items from a collection being valuated by a plurality of appraisers to cover both item-category and valuation-purpose;

FIG. 8 is illustrative of communication amongst the appraiser networked-community;

FIG. 9 is an exemplary table showing synergistic effects amongst a plurality of appraisers;

FIG. 10 is an exemplary table showing an individual appraiser getting poor performance scores and being removed from a particular item-category;

FIG. 11 is an exemplary organizational chart for executing the present invention;

FIG. 12 is an exemplary organizational chart that highlights the role of managing director;

FIG. 13a is an exemplary organizational chart that highlights the role of project coordinator;

FIG. 13b is an exemplary table showing synergistic effects amongst a plurality of appraisers that may be enabled by the project coordinator;

FIG. 13c is an exemplary table showing the various deadlines for valuating a plurality of collections;

FIG. 13d-13e show exemplary screenshots for how Project Coordinator may promote and monitor productivity in the community by establishing assignment expectations up front in the Service Profile;

FIG. 13f shows an exemplary screenshot for how Project Coordinator may distribute assignments to Inventory Specialists;

FIG. 13g shows an exemplary screenshot for how Project Coordinator may distribute assignments to Catalog Specialists;

FIG. 13h shows an exemplary screenshot for how Project Coordinator may assign work to individuals, groups of appraisers or pool of generally-available appraisers;

FIG. 13i shows an exemplary screenshot for how Project Coordinator may distribute assignments to Appraisers;

FIG. 13j shows an exemplary screenshot for how Project Coordinator may distribute assignments to Review Specialists;

FIG. 14a is an exemplary organizational chart that highlights the role of inventory specialist;

FIG. 14b is an exemplary collection of TPP that may be inventoried by an inventory specialist;

FIG. 14c shows an exemplary screenshot for how an Inventory Specialist sets availability windows for appointments to conduct on-site inventory meetings;

FIG. 14d shows an exemplary screenshot for how Inventory Specialist may manage appointments and assignments;

FIG. 14e shows an exemplary screenshot for how Inventory Specialist may submit completed assignments as uploaded files, photo albums, or references in notes;

FIG. 14f shows an exemplary screenshot for how Inventory Specialist might be accountable for managing billable time practice management;

FIG. 15a is an exemplary organizational chart that highlights the role of catalog specialist;

FIG. 15b is an exemplary table that may be enabled by a catalog specialist;

FIG. 15c shows an exemplary screenshot for how Catalog Specialist may manage assignments;

FIG. 15d an exemplary screenshot which shows how a Catalog Specialist may complete assignments using long form for each line item;

FIG. 15e shows an exemplary screenshot for having an exemplary listing of Artists/Makers and biographical information about each;

FIGS. 15f-15g shows an exemplary screenshot having an exemplary set of characteristics used to catalog an item;

FIG. 15h shows an exemplary screenshot illustrating a set of cataloged items that may be reviewed by Catalog Specialist before finalizing the collection for subsequent appraisals;

FIG. 16a is an exemplary organizational chart that highlights the role of appraisers;

FIG. 16b is an exemplary table showing a plurality of appraisers providing separate valuations for the same item;

FIG. 16c shows an exemplary screenshot illustrating a set of items that have been offered to an Appraiser for their possible acceptance for subsequent appraisal;

FIG. 16d shows an exemplary screenshot illustrating where an Appraiser declined an offered appraisal assignment;

FIG. 16e shows an exemplary screenshot illustrating a set of accepted valuations that an Appraiser has accepted;

FIGS. 16f-16i show exemplary screenshots illustrating where an Appraiser has further described the item based on their own knowledge and discovery efforts, including collaborating with the network community peers;

FIG. 16j-16k show exemplary screenshots illustrating where an Appraiser has identified comparable items that were considered when attempting to appraise the subject item;

FIG. 16l shows an exemplary screenshot illustrating where an Appraiser has entered notes that may be useful to a variety of people;

FIG. 16m shows an exemplary screenshot illustrating where an Appraiser has entered their appraised valuation for the item;

FIG. 16n-16p show exemplary screenshots illustrating a table of completed valuations that were assigned to the Appraiser;

FIG. 17 is an exemplary organizational chart that highlights the role of review specialist;

FIG. 18 shows a non-limiting, exemplary embodiment of an organizational model to illustrate the fact that a customized group of team members may be established for a variety of TPP collections;

FIG. 19 shows a non-limiting, exemplary embodiment of a communication network to illustrate the fact that the various resources/members of the network community find value in collaborating;

FIG. 20 shows a non-limiting, exemplary embodiment of a collection of databases that comprise the various types of useful data that are useful to this present invention; and

FIG. 21 shows an exemplary screenshot illustrating where a set of completed valuations performed by a variety of Appraisers across a variety of TPP.

### DETAILED DESCRIPTION OF THE INVENTION

Many people collect valuable stuff. Whether a person is a professional collector of fine art items, or a widow who has inherited a large estate, anyone who has a large collection of items struggles with knowing the value of such items. Such items (commonly referred to as tangible personal property, TPP) can comprise of a large variety of items and having a wide range of value. The larger the TPP collection (i.e., number of items), the more difficult it becomes to quickly and accurately place a correct value on such items. The present invention solves these problems and other related issues.

While the present invention is not limited to containing each of the following steps, an exemplary embodiment of the present invention includes a method for appraising large collections, often containing hard-to-value specialty TPP. Such exemplary methods provide for better identification, organization, valuation and management of a numerous group of objects that mostly fall into a wide range of categories (e.g., fine arts, jewelry, ceramic vases, furniture, etc.). Said exemplary method steps include:
A. Organization
B. Triage
C. Collaboration
D. Validation
E. Assessments
F. Maintaining a talent pool

### A. Organization (Identifying and Describing the Collection):

In a first example, a client has a large, varied collection of tangible personal property (TPP) containing such items as paintings, ceramics and jewelry. Prior to our invention, the client would be required to work with a multitude of appraisers for the timely and accurate valuation of their TPP collection. Because the various objects in the TPP collection are completely different in terms of purpose, intended-use, manufacturer/maker, age, marketability and many other characteristics, there does not exist a single appraiser that is qualified to value every single item of the TPP collection. Subsequently, multiple appraisers are necessary to competently value the TPP in a timely fashion. Moreover, these multiple appraisers can't readily collaborate and work in a network fashion; as such, there are no shared-learnings and synergistic effects. Further, today all of the various appraisers would be required to personally visit and inspect each TPP in person.

With the present invention, the client can easily contact our Managing Director who will quickly review the TPP collection, define the client's problems to solve (for example, if the collection is being assessed for insurance purposes or for an estate settlement or planning) and formalize the commercial relationship (e.g., negotiate and contract the terms of service). Additionally, the Managing Director will create a client account and subsequently assign it to a Project Coordinator.

The Project Coordinator will review the TPP collection and then allocate sets of tasks necessary to solve the client's problems. Among these tasks, the Project Coordinator will assign an Inventory Specialist to visit the client's property and gather pertinent information about the TPP collection, which will be necessary to create a reliable and highly-organized catalog. The present invention would include a network of Inventory Specialists. Our network database is continuously refined by adding newly-qualified Inventory Specialists, promoting/ranking Inventory Specialists and/or removing poor-performing Inventory Specialists. Further, the present invention also enables the Inventory Specialist to go onsite to examine the TPP on behalf of the various appraisers who would otherwise be required to do so themselves.

The Inventory Specialist, during a visit to the client's property, for example, collects relevant facts, photographs and related information. The Inventory Specialist will describe each item in a record, noting its physical properties (e.g., item dimensions) and characteristics (e.g., cracks in the paint). These item details are required for the Appraisers to competently value the items, all without being required to visit the client's site to personally examine the TPP themselves.

The Inventory Specialist will transfer this metadata to a Catalog Specialist who will enter the records of each item into a searchable, sortable database that is secure and client-specific. Each item in the TPP collection is recorded and categorized within the database. The present invention would include a network of Catalog Specialists. Our network database is continuously refined by adding newly-qualified Catalog Specialists, promoting/ranking Catalog Specialists and/or removing poor-performing Catalog Specialists.

At this point the TPP collection is ready for appraisal. Because of the unique approach of leveraging an Inventory Specialist and Catalog Specialist, the present invention does not generally require Appraisers to visit the client's property/residence. Instead, the Appraisers can enjoy the cataloged information from a trusted network of specialists that are organized in a unique method of doing business.

### B. Triage (Finding and Assigning the Right Appraisers):

The present invention is unique in its ability to find the right appraiser(s) for a particular valuation and for a particular valuation purpose. The triage process includes the step of the Catalog Specialist producing a collection-catalog of the client-owned objects and assigns a category to each object. For example, a Rookwood Pottery ceramic vase would be cataloged in the ceramics category. Each object is entered into the database to be matched with an Appraiser whose expertise corresponds with that item and its category. The Appraiser may be selected from our network of certified Appraisers.

In this example, the decorative arts category may be categorized as art that is meant to be useful and beautiful, and is often produced in ceramics, metalwork, glass and textiles. A Rookwood Pottery ceramic vase is an example of an item that would be categorized by the Catalog Specialist as belonging to the decorative arts category.

Within the present invention, for example, it may be desirable for items within the decorative arts category to only be valued by Appraisers who have demonstrated the qualifications to value such items. Further, it may be desirable to offer special certifications to Appraisers to be recognized in their field/industry for select item categories. For example, if Appraiser Cathy is a ceramic vase specialist and is working on the platform at the same time an assignment becomes available for a client who owns a painting, a ceramic vase and fine jewelry, she will only have viewing privileges for the ceramic vase valuation assignment. Since Cathy is not qualified in the categories of paintings and jewelry, those valuation assignments will not be visible to her. This function helps Cathy stick to what she knows—ceramic vases—rather than risk the temptation of working outside of her area of expertise.

Sub-categories can further specify the expertise assigned to the item. For example, an Appraiser can demonstrate her qualification to competently value late-American pottery, a sub-category of the decorative arts category. This allows us to automatically assign the most focused, knowledgeable and experienced Appraiser to each item because the system validates all appraiser qualifications within the item category and then matches the objects to the best-suited Appraiser.

### C. Collaboration (Leveraging the Community of Appraisers):

The present invention provides a system for creating a network/community of Appraisers. Within this network, the Appraisers have the unique ability to collaborate in real time, regardless of the Appraisers' locations and/or timezones. Such a network system enables:
1. Peer reviews of valuation assignments, facilitated by the system, upon which Appraisers can offer feedback.
2. Access to historic valuation data within the system's proprietary database of appraisals, which reveals the historical valuation reasoning and support provided by their peers on previous items of similar Like, Kind and Quality. For example, the system provides the ability for Appraisers to remotely discuss a tricky painting with other qualified experts and draw a conclusion based on their professional opinions.
3. Access to an artist/maker database for examples of attributions across our past assignments. This enables appraisers to more readily and accurately attribute a rare painting to the original artist, by accessing multiple examples of that artist's work and referencing stylistic attributes consistent with the artist's work—such as the scale, the style or form, the subject matter and the method/process of creation.

### D. Validation (Providing and Validating the Appraisals):

The present invention is unique in its ability to validate an Appraiser's valuation through peer review and/or comparison. For example, to further ensure we assign the best appraiser, each completed valuation assignment is reviewed, scored and, when necessary, duplicated and distributed among multiple Appraisers. In some situations, it may be desirable to not inform an Appraiser that their qualified peers (i.e., other Appraisers) may be performing the same valuation assignment. Such concealed, duplicate appraisals can help validate certain appraisals that require a greater level of scrutiny (e.g., tax filings).

To ensure greater validation, it may be desirable for the Project Coordinator to review all the valuations from the Appraiser(s) who have worked on a particular TPP-collection. Further, the Project Coordinator may send a report to the Managing Director, who then uses those independent valuations to establish a measured, standard deviation. If an Appraiser's valuation assignment falls outside of the standard deviation calculation established by her peers on the same assignment, she may be listed as poorly-qualified. If it falls well within the standard deviation, she may be rated as highly-qualified. As a plurality of valuations are made and scored across the network of Appraisers, the community network itself will become more fine-tuned (e.g., best appraisers identified for select item categories and/or valuation purposes).

### E. Assessments (Scoring Performances and Grading Appraisers for Each Role):

The Appraisers in the database may further be scored based on the number of encounters they have had with the objects that fall within their qualified categories (e.g., the number of ceramic vases that Appraiser Cathy has assessed). The appraisers' experience and education may also be weighted into their overall score.

These scores are helpful to gauge which Appraisers are not only most competent, but also the most efficient at their work. Furthermore, the system may include a billing and time-tracking tool to measure the Appraisers productivity and effectiveness. This measure of accuracy and efficiency is unique to the industry and is designed to save our clients the potential stress and hardship of a prolonged appraisal process. Put another way, the present invention is designed to ensure greater peace of mind, security and cost efficiency for our clients.

### F. Maintaining a Talent Pool (Managing the Health of the Community):

In addition to achieving better, faster and validated appraisals through our network community, the members of our network (e.g., Appraisers) benefit by working with and learning from each other.

In an example wherein an Appraiser is not performing well within a particular item category, he may be granted the opportunity to collaborate with other qualified Appraisers for mentoring. Through such mentorship, the Appraiser may improve his standing within that particular item category and/or get qualified in another item category wherein he shows stronger competency therein.

In another example, assume Appraiser Cathy has not accrued enough experience in appraising items in the paintings category. She can easily collaborate with Appraiser Bob, who is qualified within the network for that particular item category. Additionally, she could watch and observe his approach to valuations, his research process, his presentation of comparables and his justified reasoning for the valuation.

This feature of mentorship and/or apprenticeship is unique to the present invention and revolutionary for the advancement of the appraisal industry. In a discipline like appraisal valuations, where few quality training programs exist outside of courses offered by nonprofit organizations, there is considerable value in a process for completing valuation work while also training a team. The community grows with each new client, as does our databases of metadata related to the other items we appraise. It becomes, in essence, a self-sustaining and growing community network.

For a deeper appreciation of the unique system and methods of the present invention, we offer the following illustrative, exemplary embodiments:

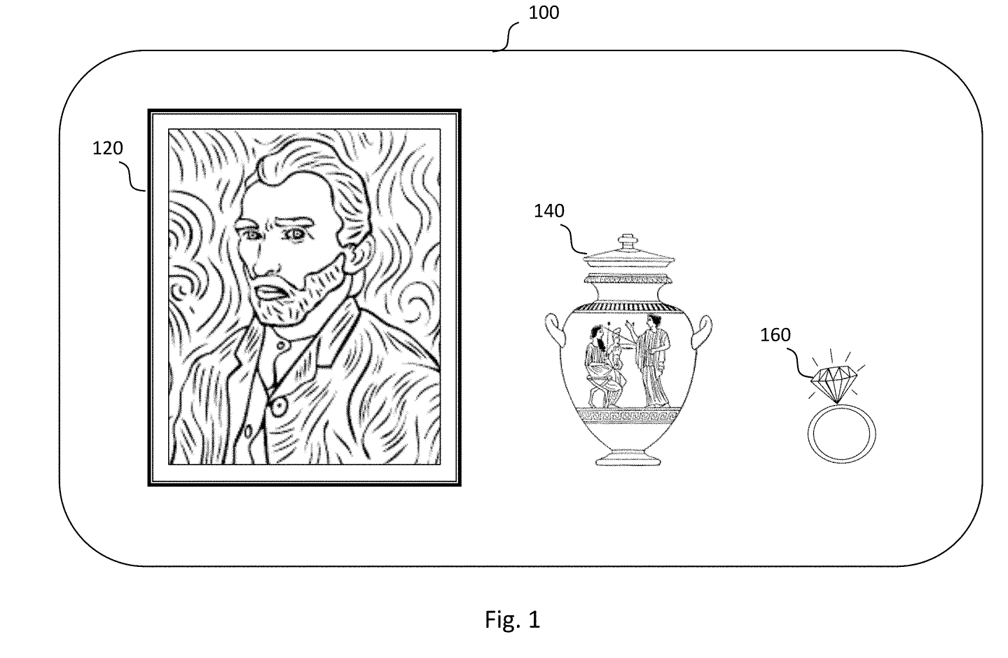

FIG. 1 shows a non-limiting, exemplary embodiment of a TPP collection 100 containing a painting 120, ceramic vase 140 and jewelry 160. This TPP collection 100 is illustrative of many other TPP collections commonly found amongst collectors, beneficiaries and many other types of people or entities. For this example, assume Joan inherited a collection that contains dozens of items that fall into a wide range of categories (1), including undocumented paintings, rare ceramics and precious jewelry. Unsure what to do with the property, or even its value, she contacts Bryson Estates who uses the present invention.

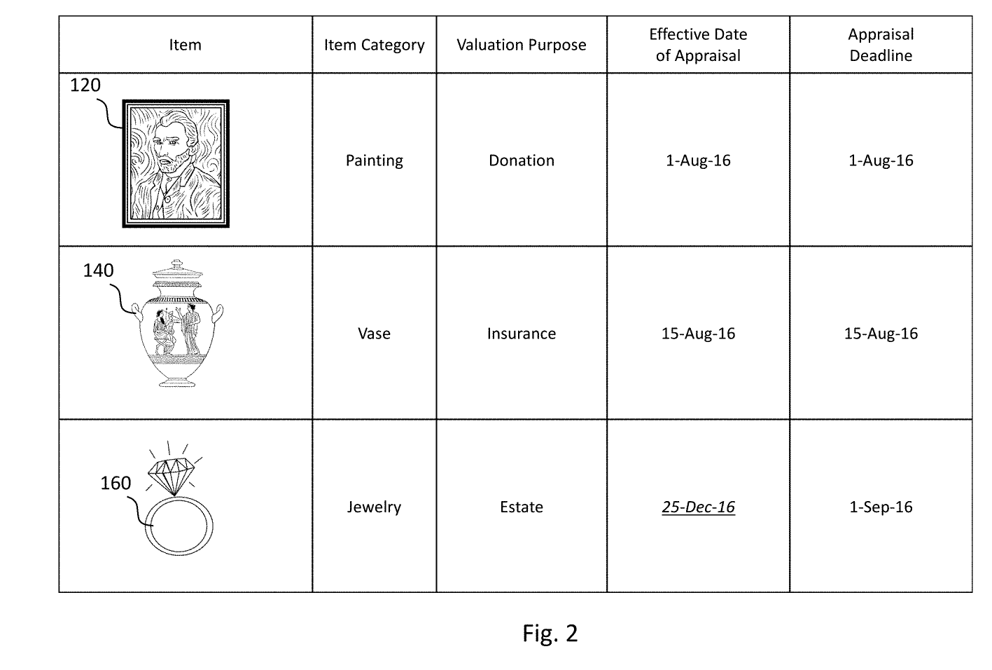

Upon reviewing Joan's needs, Bryson Estates assigns the TPP collection 100 to a Managing Director, who appoints a Project Coordinator. The Project Coordinator enters each item within the TPP collection into our system, categorizing each piece by item, appraisal dates and valuation purposes, such as for donation, insurance or estate. See FIG. 2.

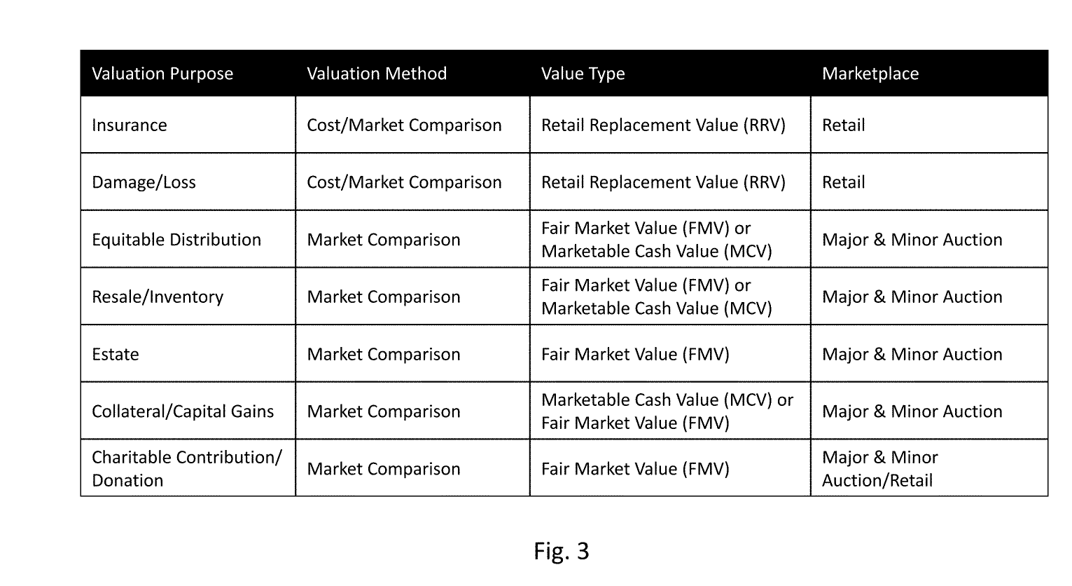

As the Project Coordinator seeks to understand the corresponding item categories and valuation purposes, the system will advise the Appraisers as to the appropriate appraisal approach, value type and marketplace for valuation. See FIG. 3. This unique approach is a significant improvement over the non-strategic approach to valuating items by appraisers today within the prior art which often causes the client to incur substantial losses (e.g., over-payment in taxes, insufficient sale price and lengthy process to value a large group of TPP).

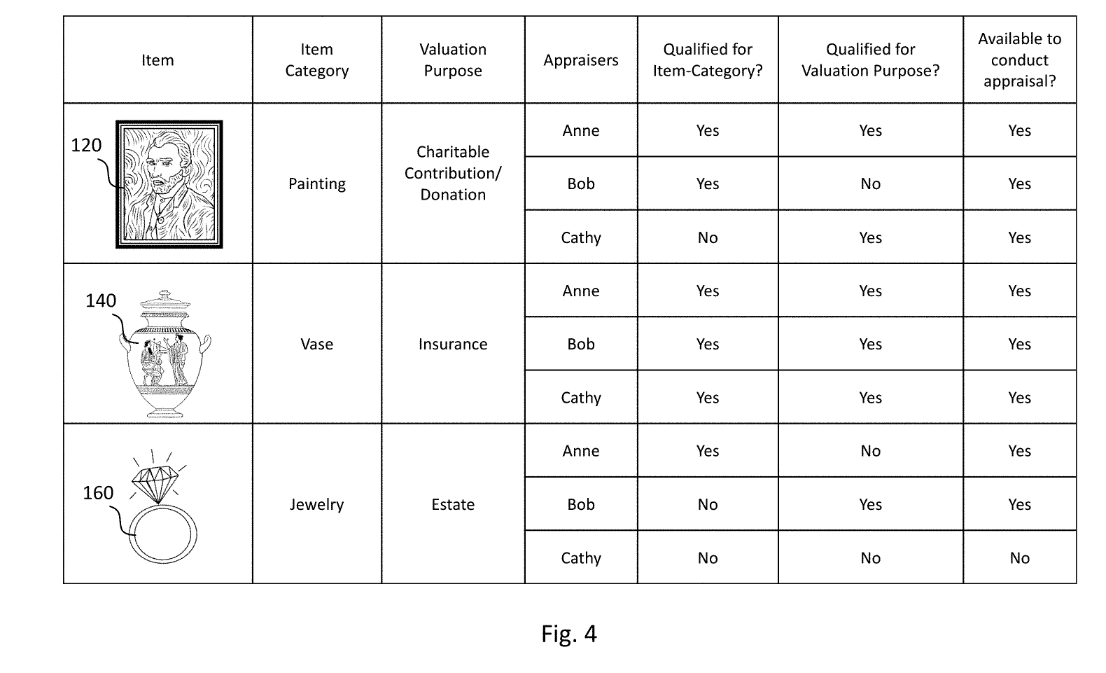

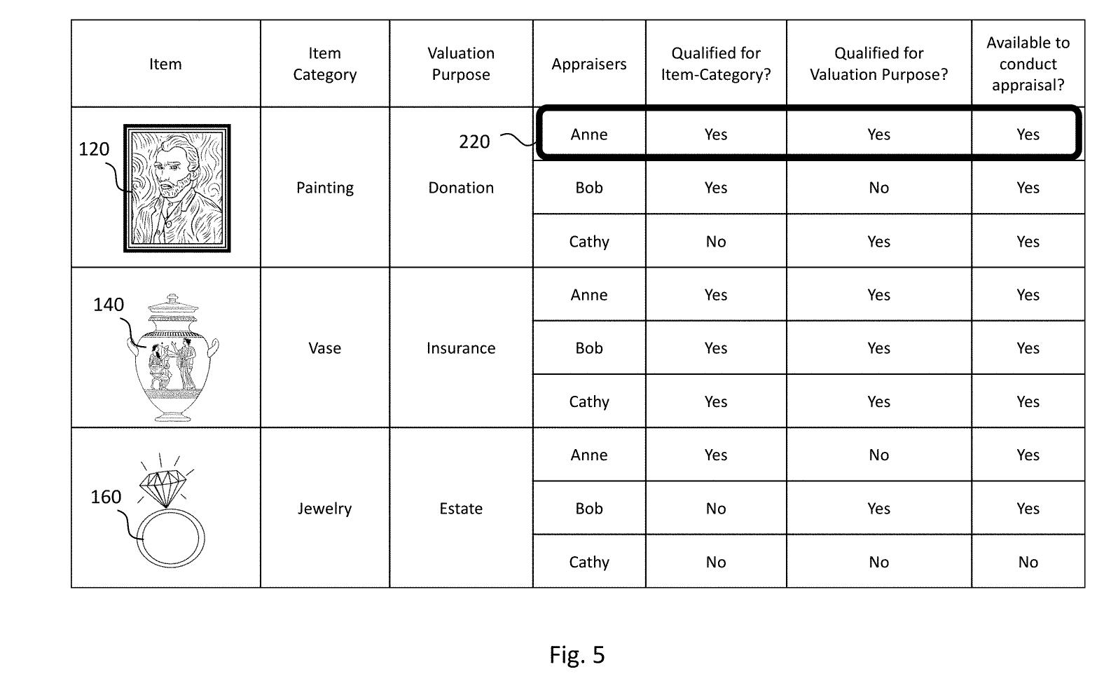

FIG. 4 shows a non-limiting, exemplary embodiment wherein the Project Coordinator identifies the most qualified Appraisers for the items in their respective item categories and valuation purposes. FIG. 5 shows a non-limiting, exemplary embodiment wherein the Project Coordinator assigns painting 120 to Appraiser Anne based upon her qualifications and availability as shown in appraisal assignment 220.

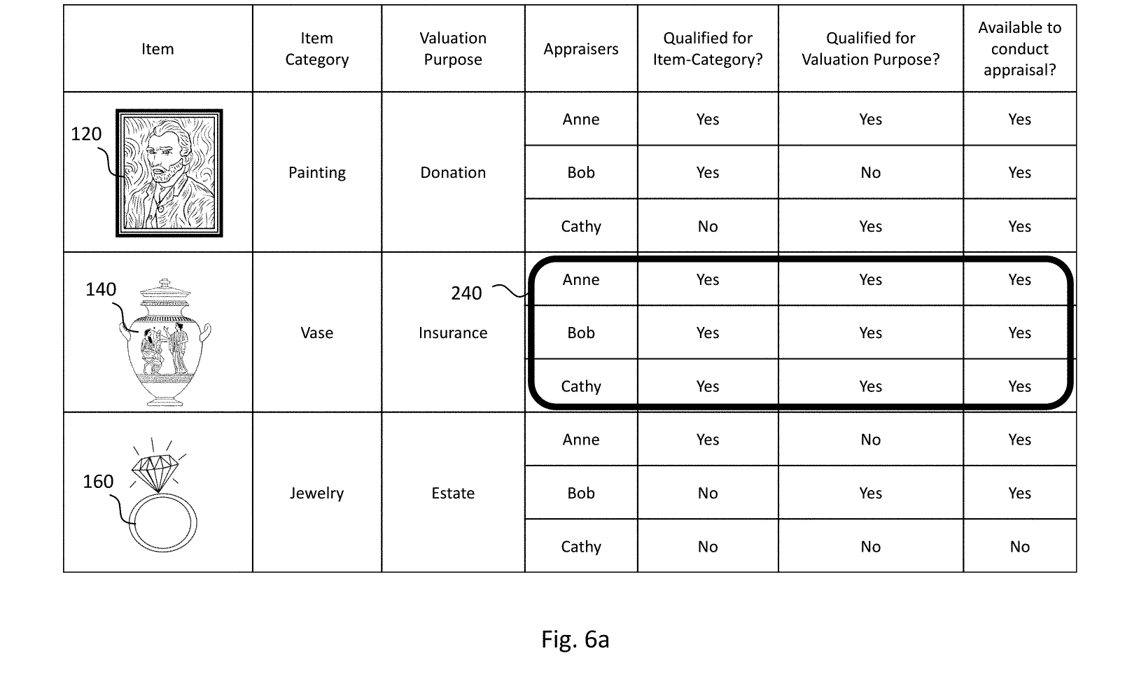

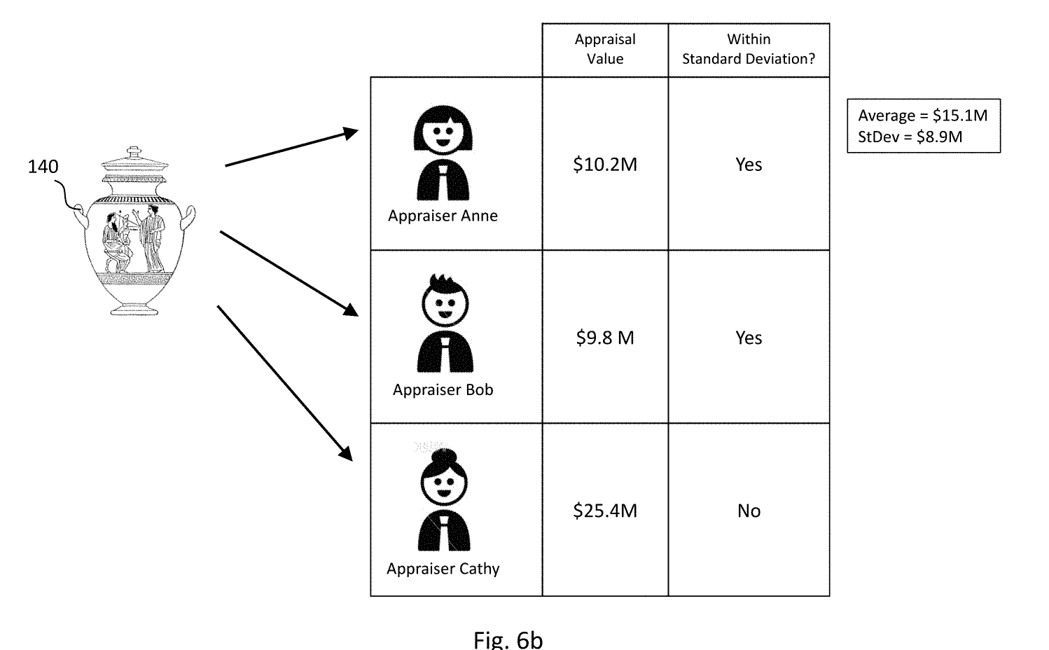

FIG. 6a shows a non-limiting, exemplary embodiment wherein the Project Coordinator assigns ceramic vase 140 to Appraiser Anne, Appraiser Bob and Appraiser Cathy based upon their qualifications and availability as shown in appraisal assignment 240, wherein the client's needs required multiple appraisals to be conducted. FIG. 6b shows a non-limiting, exemplary embodiment wherein multiple Appraisers provide appraisal values for the same ceramic vase 140. In this example, the appraisal value from Appraiser Cathy is outside of the standard deviation; therefore, her appraisal value is voided.

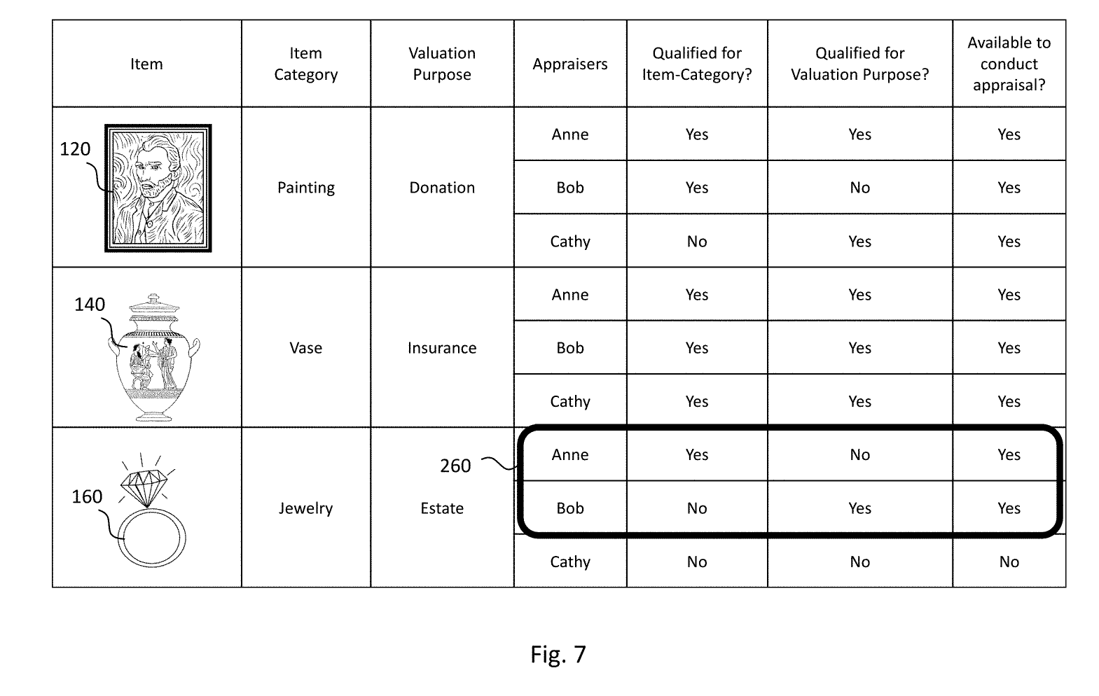

FIG. 7 shows a non-limiting, exemplary embodiment wherein the Project Coordinator assigns jewelry 160 to Appraiser Anne and Appraiser Bob as both of them are required to provide coverage for both the item category and the valuation purposes. In this example, neither Appraiser is sufficiently qualified to appraise the item by themselves, however, working together they could do so.

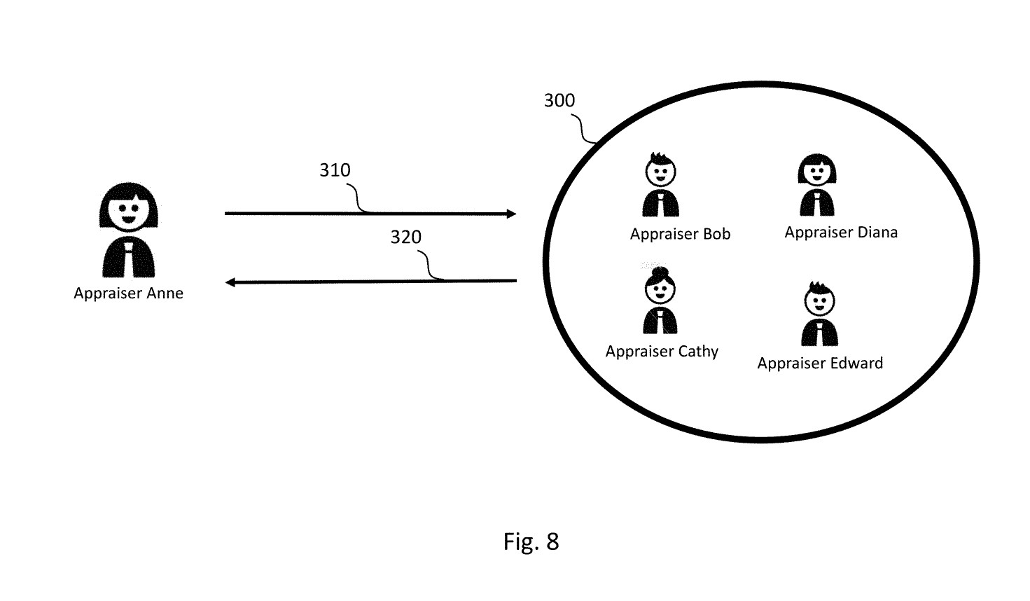

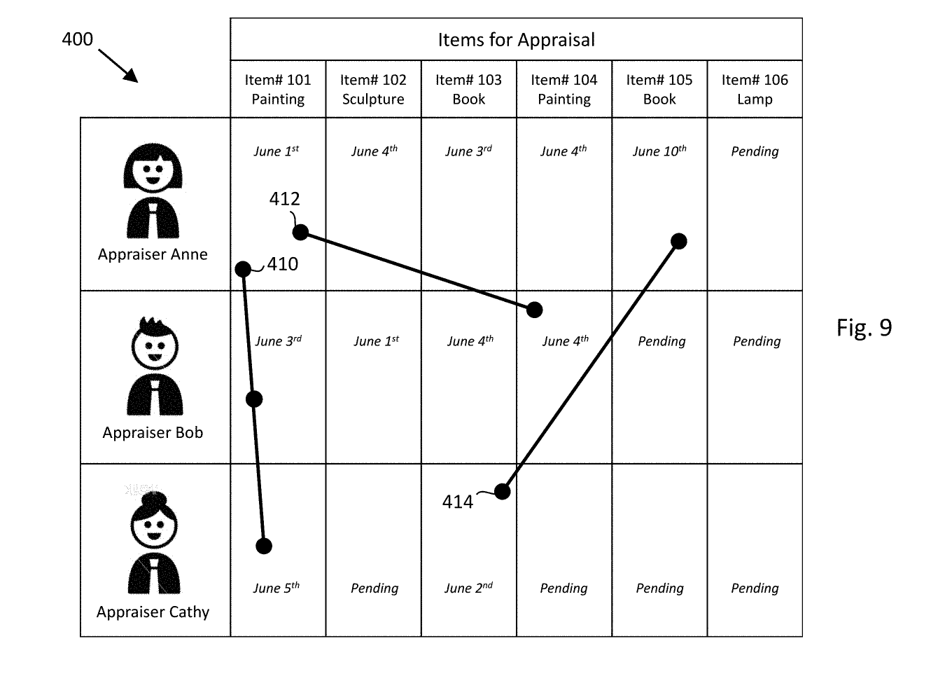

FIG. 8 shows a non-limiting, exemplary embodiment wherein an Appraiser Anne has a communication 310 with the network community 300 and the network community 300 has a communication 320 with her. In this way, the community of appraisers collaborate to provide improved appraisals while simultaneously improving the effectiveness of the network community itself. FIG. 9 shows a non-limiting, exemplary embodiment of an assignment table 400 wherein synergistic effects occur. For example, within synergistic effect 410, the Appraisers collaborate sequentially to improve and validate the appraisal of a particular painting. Within synergistic effect 412, the Appraisers collaborate on different, but related paintings to validate the authenticity of each painting by the same purported painter. Within synergistic effect 414, the Appraisers similarly collaborate on different books to improve their respective appraisals by providing market comps for similarly situated items.

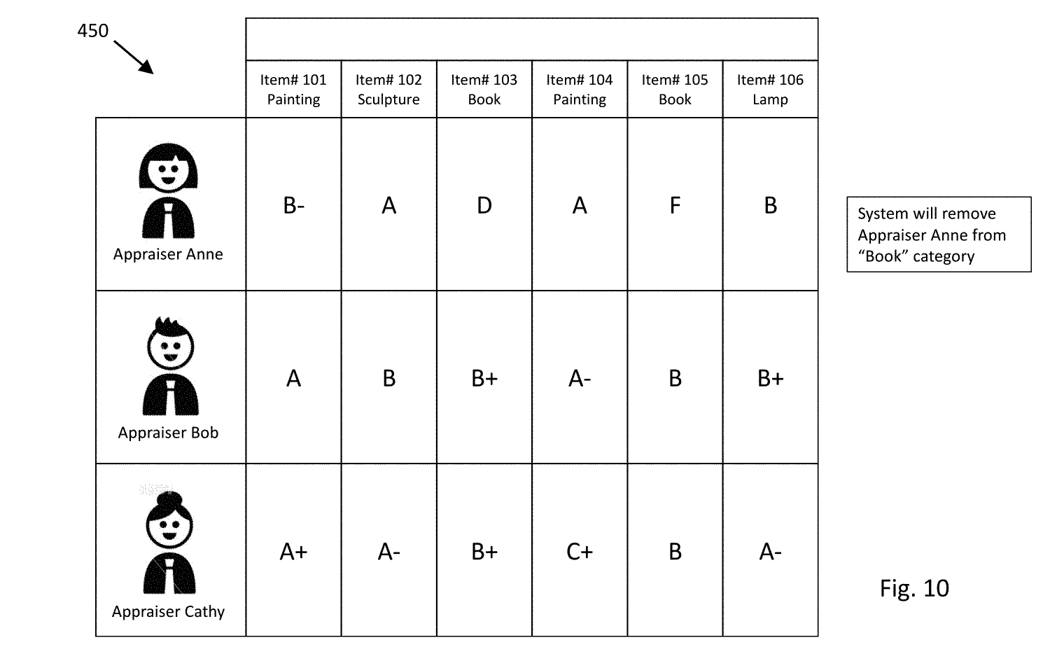

FIG. 10 shows a non-limiting, exemplary embodiment of an appraiser grading sheet 450 wherein the Appraisers are scored for the overall performance on individual item appraisals. Additionally, the system could assess Appraiser Anne as poor performing within the item category of books and subsequently remove her from the network of qualified-appraisers for books.

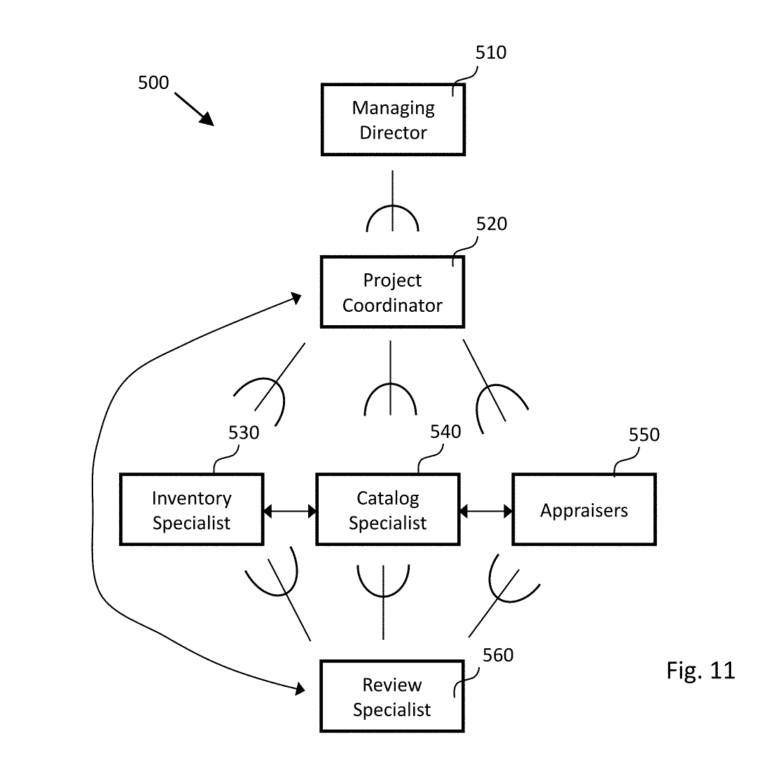

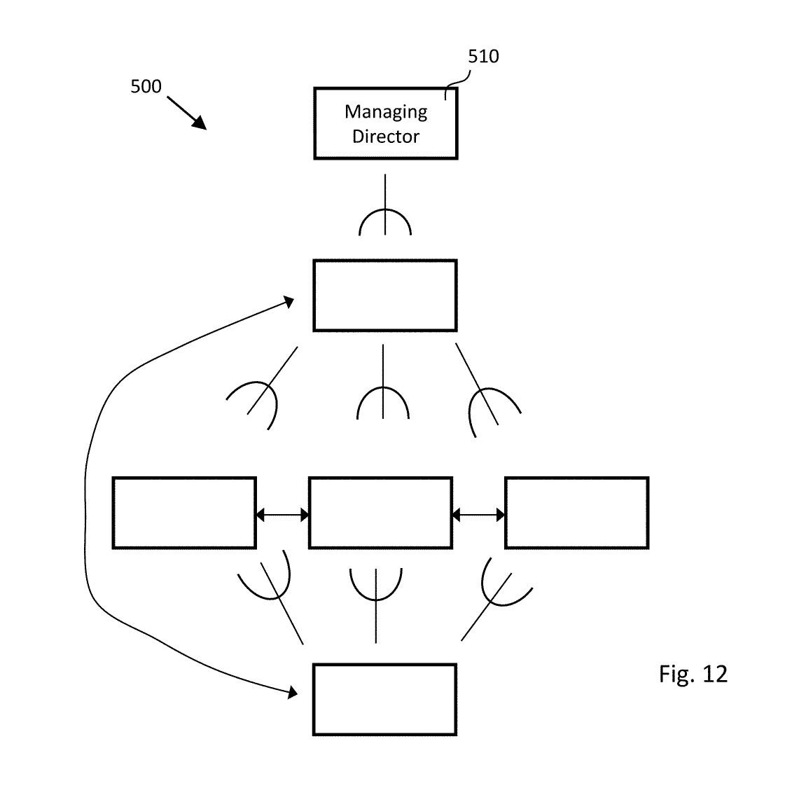

FIG. 11 shows a non-limiting, exemplary embodiment of an organizational model 500 for delivering the system and methods of the present invention. FIG. 12 highlights the Managing Director 510 and she essentially oversees the health and operational effectiveness of the entire system and network community. Other key responsibilities of Managing Director 510 include: (a) ensure integrity of the final report to the client, (b) ensure the health of the network community and (c) ensure the entirety of the client's collection is properly appraised and meets the needs of the client in a manner consistent with professional appraiser conduct.

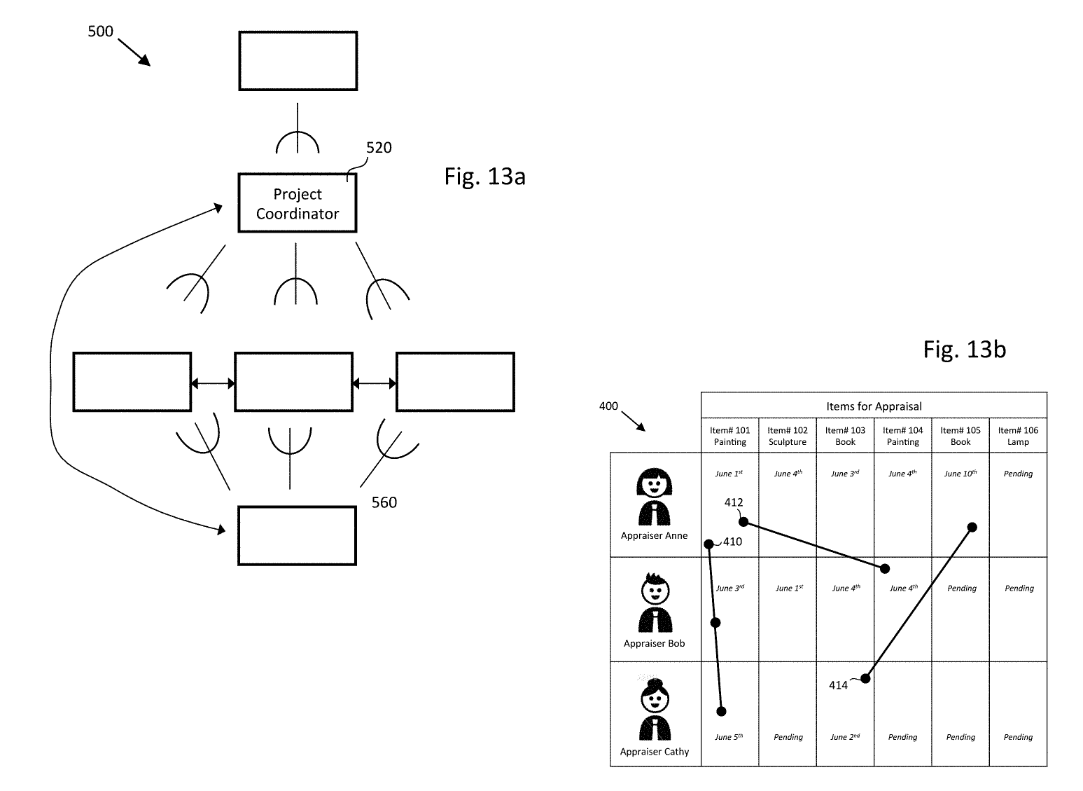

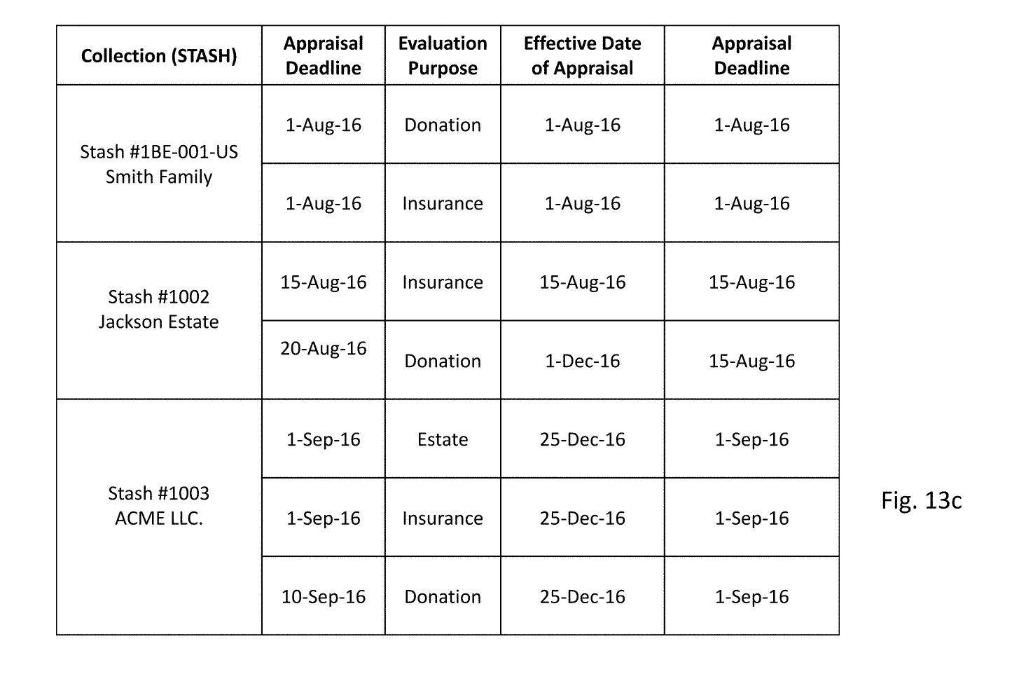

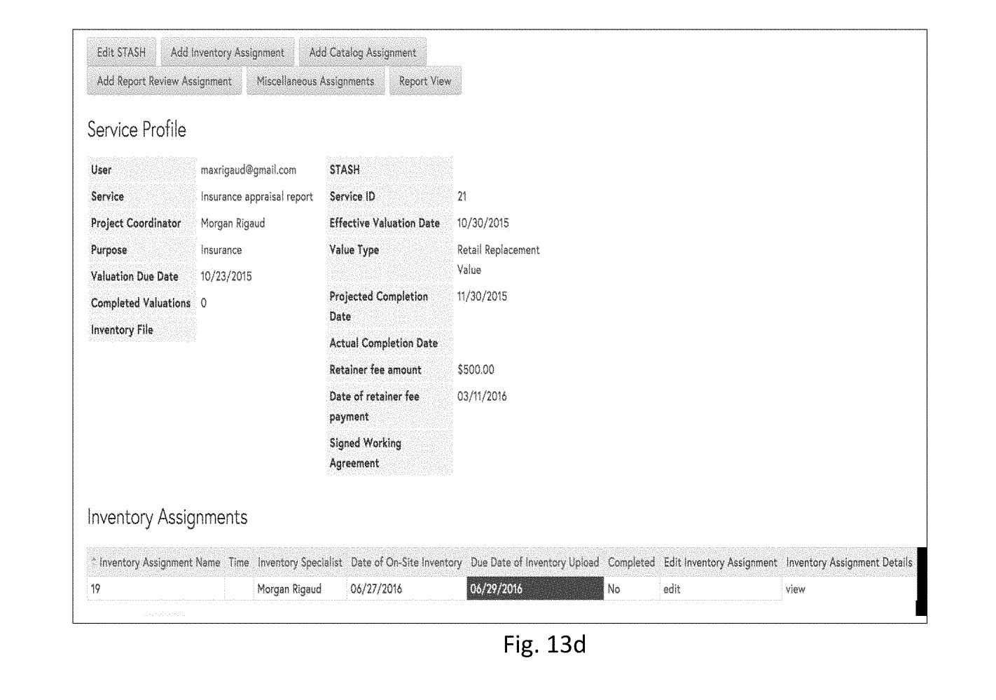

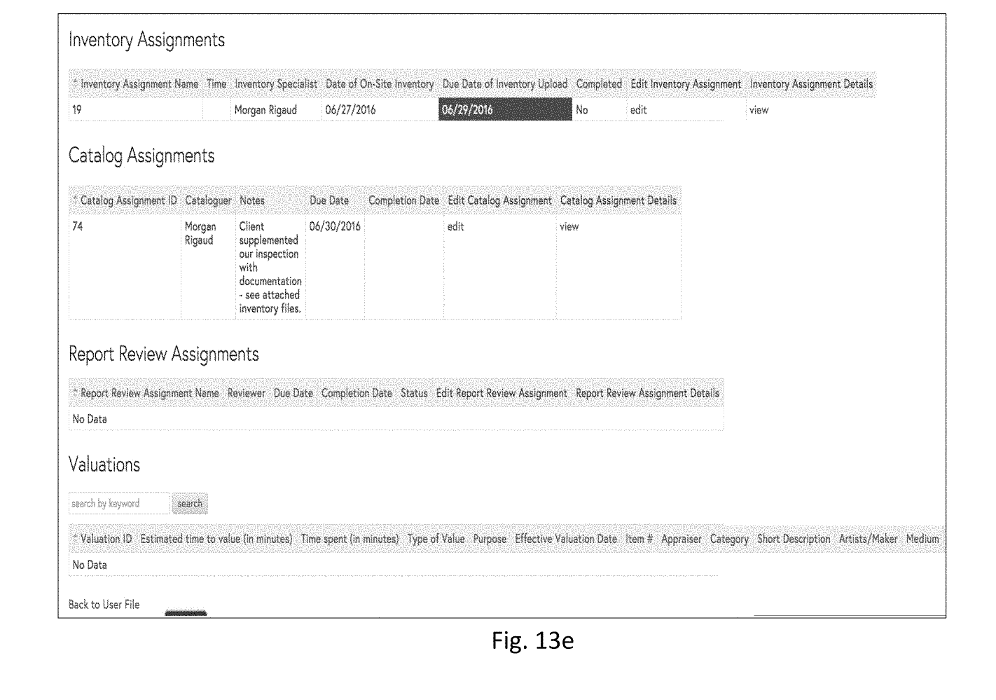

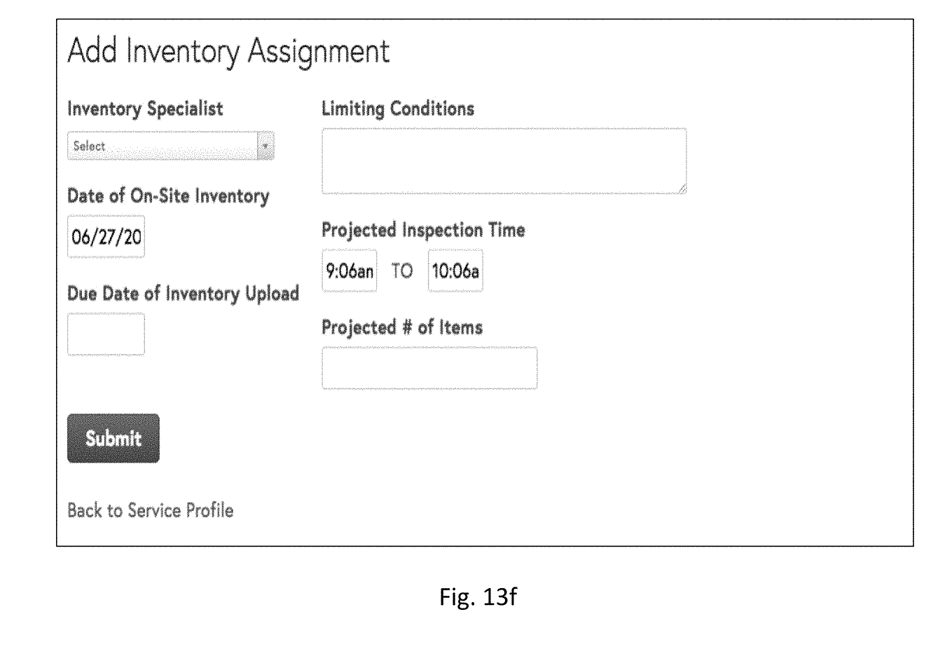

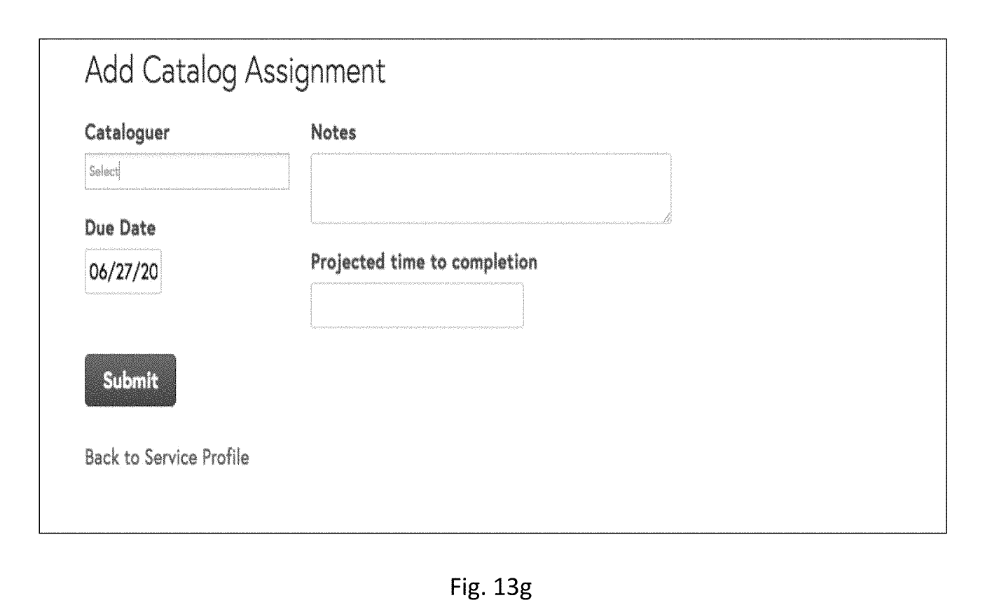

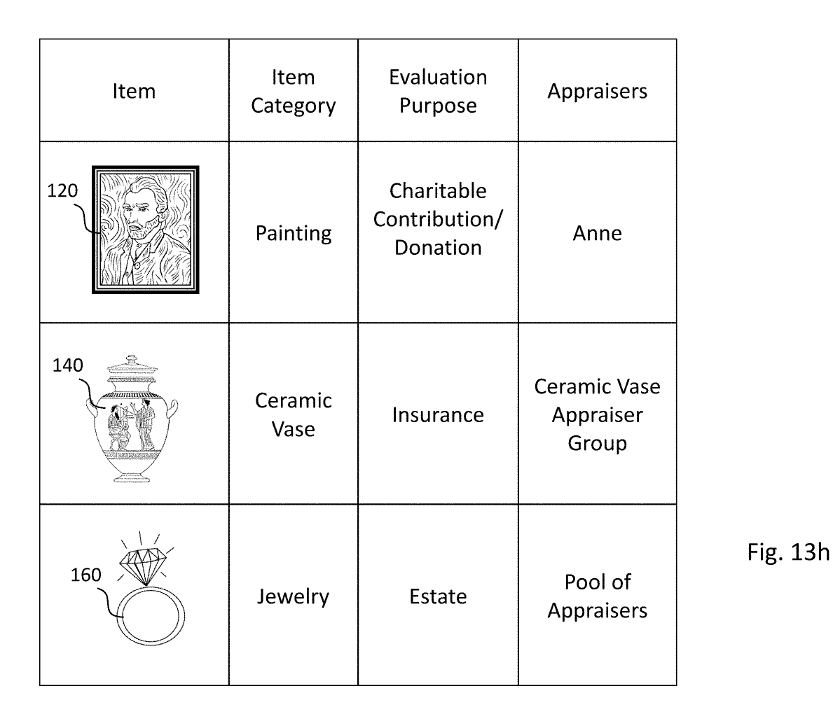

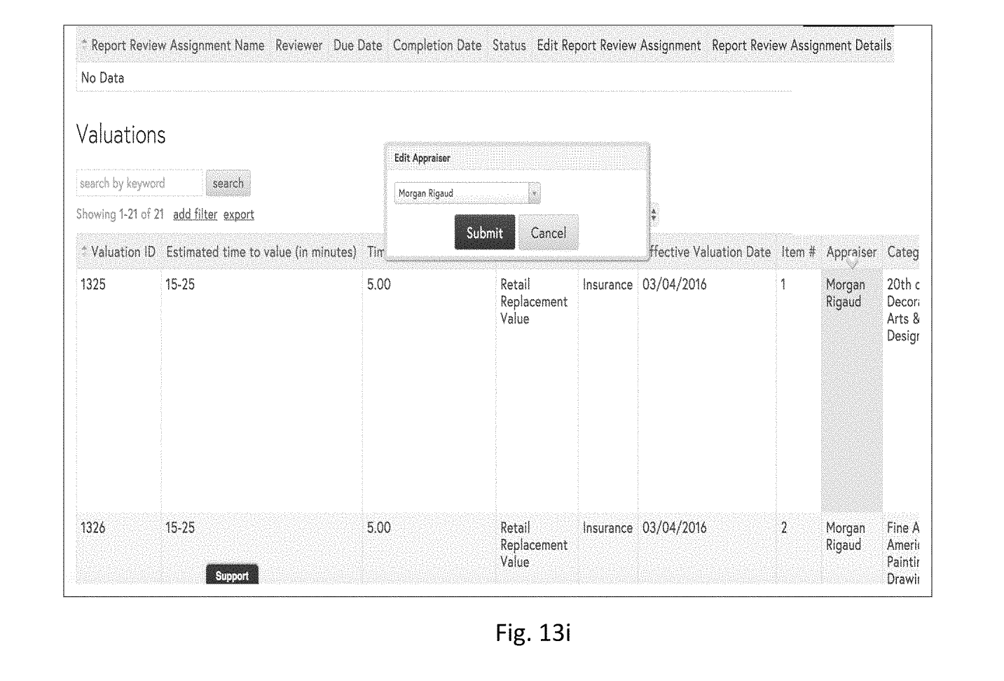

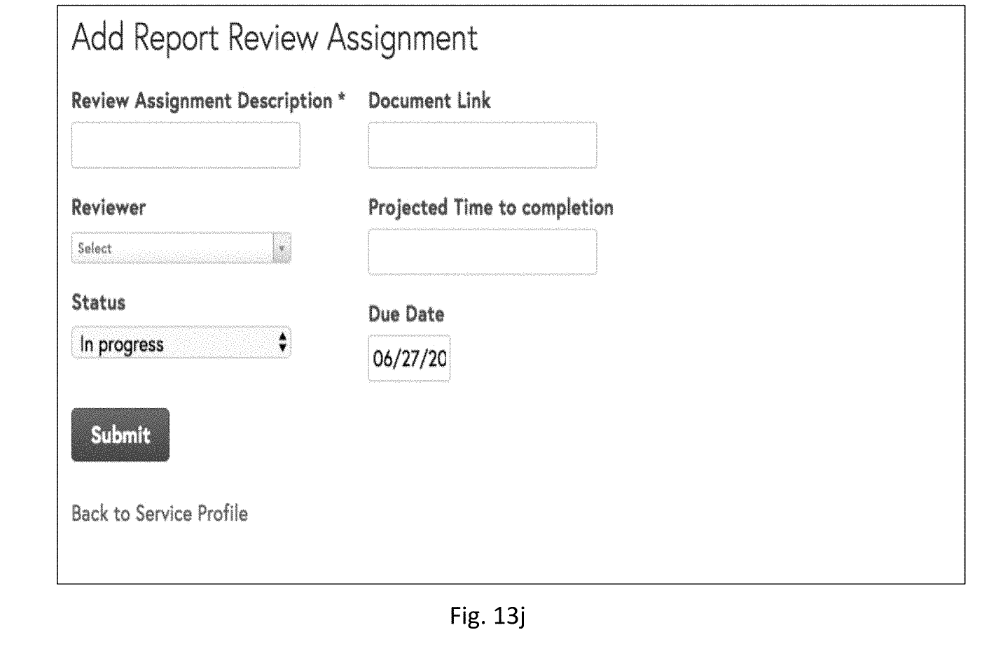

FIGS. 13a and 13b show a non-limiting, exemplary embodiment of an organizational model 500 wherein the Project Coordinator 520 assigns the appraisal assignments to the various Appraisers as shown in the assignment table 400. Project Coordinator 520 will valuate the context when assigning appraiser(s). For example, if a family is morally-suspect, then multiple appraisers may be needed for appraisals required by the IRS. Additionally, the Project Coordinator 520 may leverage the community to more quickly and competently appraise multiple items within a collection. Project Coordinator 520 ensures the collection of items are appraised by the committed deadline to client. Project Coordinator 520 may triage the work of the community of appraisers to meet this individual deadline.

FIG. 13c shows a non-limiting, exemplary embodiment of a plurality of collections that require appraisal contemporaneously. FIG. 13d-13e shows how a Project Coordinator may promote and monitor productivity in the community by establishing assignment expectations up front in the Service Profile. FIG. 13f shows how Project Coordinator may distribute assignments to Inventory Specialists. FIG. 13g shows how the Project Coordinator may distribute assignments to Catalog Specialists. FIG. 13h shows how Project Coordinator may assign work to individuals, groups of appraisers. FIG. 13i shows how Project Coordinator may distribute assignments to Appraisers. FIG. 13j shows how Project Coordinator may distribute assignments to Review Specialists after the appraisers have completed their valuations.

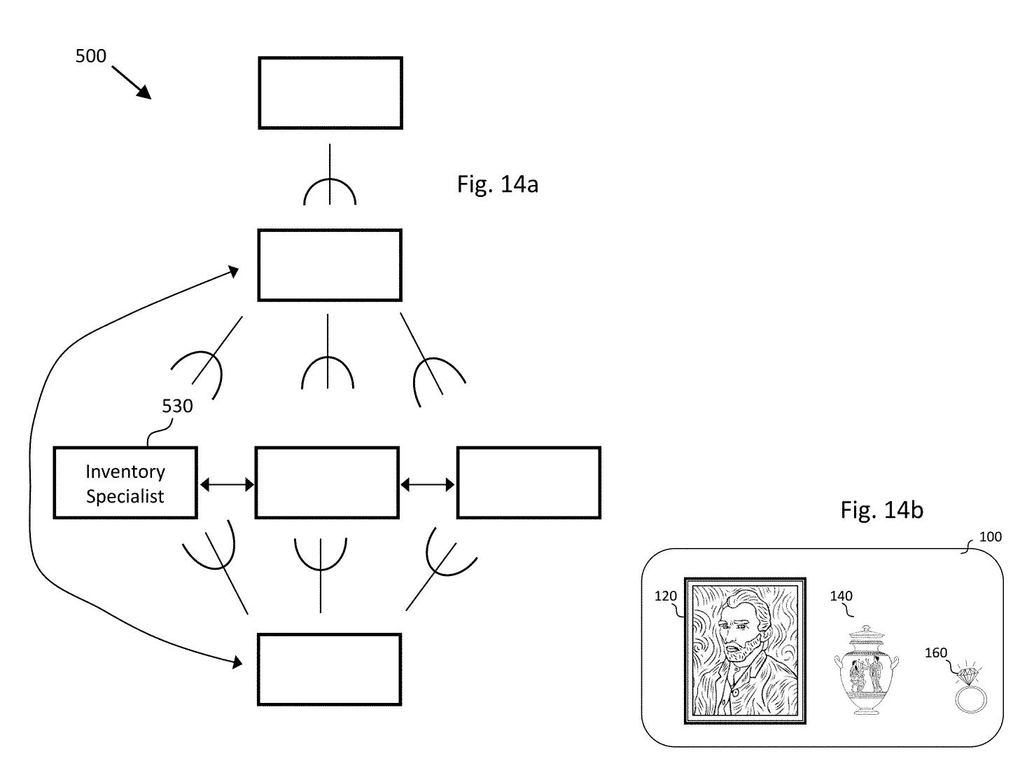

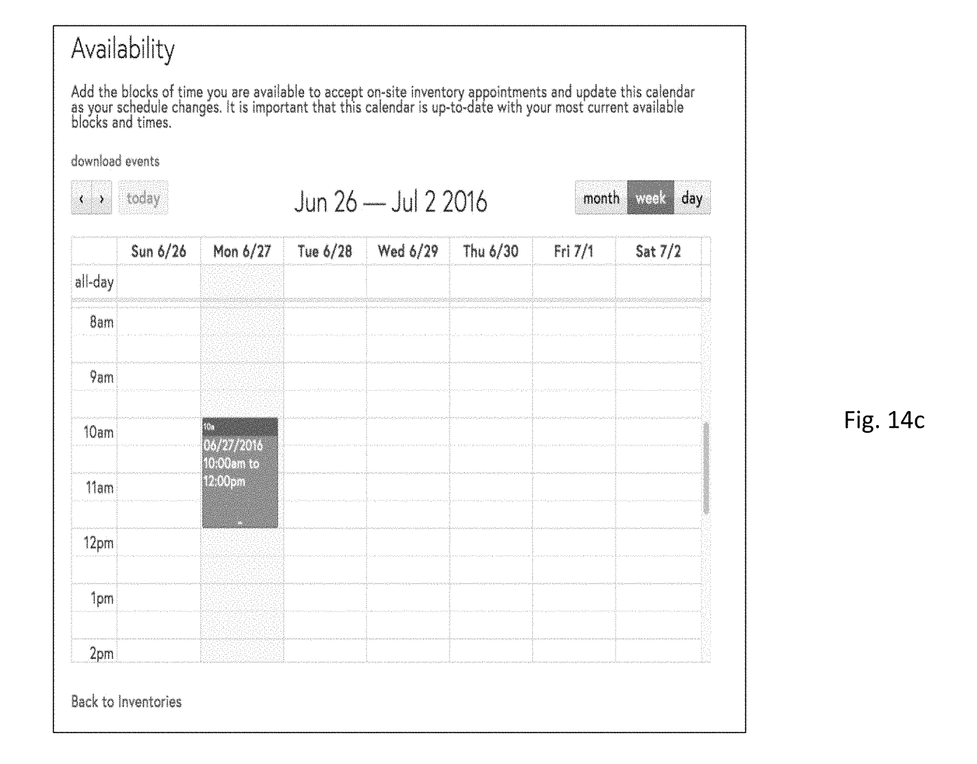

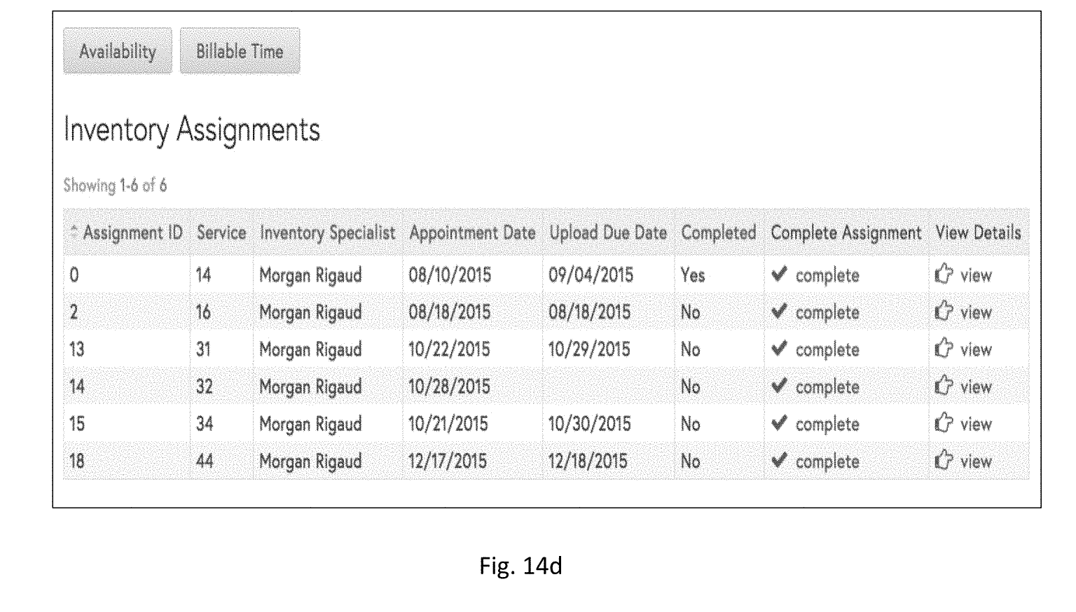

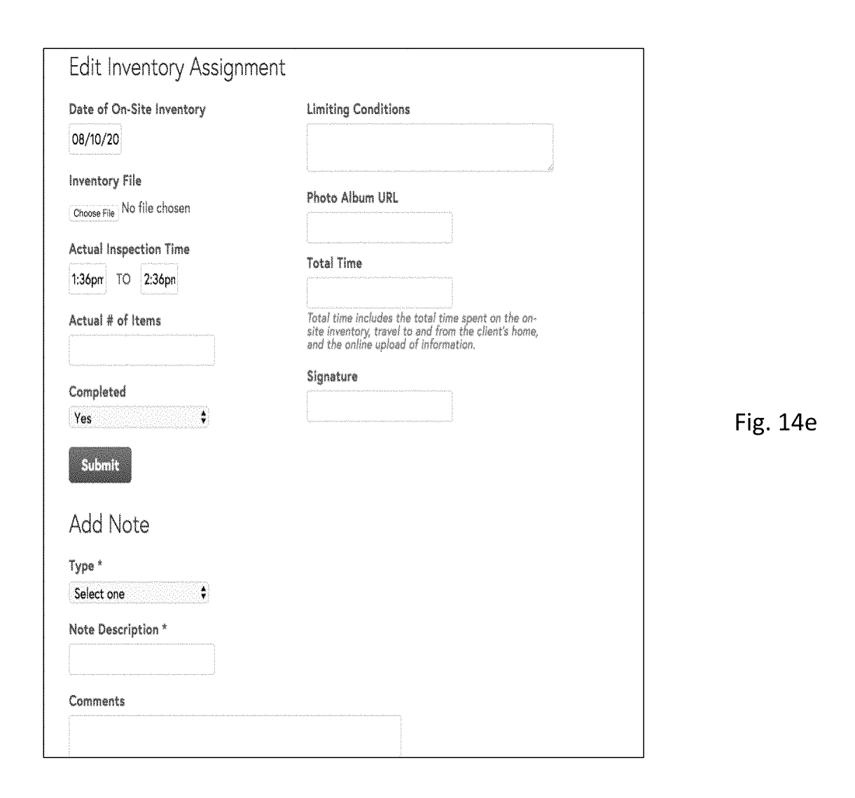

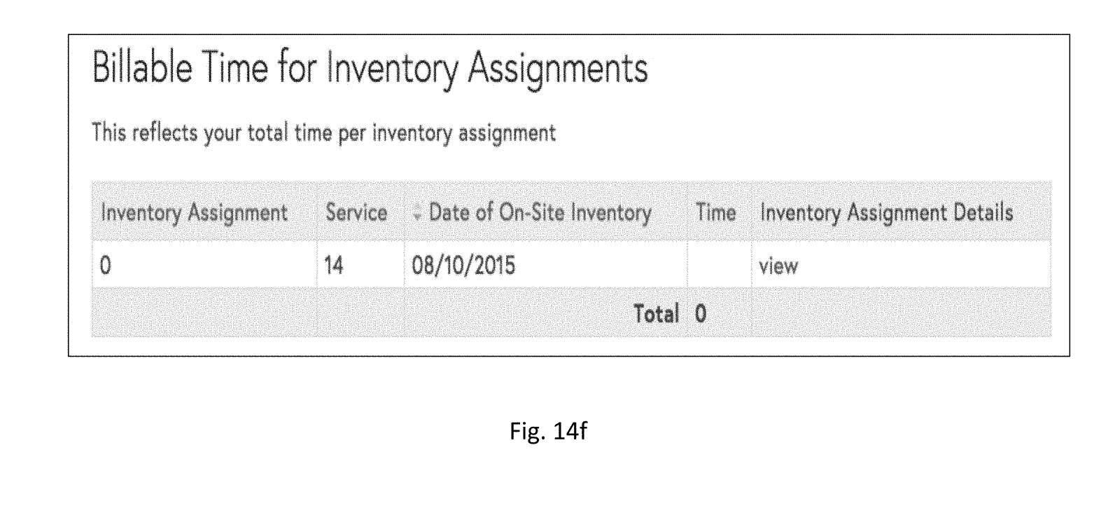

FIGS. 14a and 14b show a non-limiting, exemplary embodiment of an organizational model 500 wherein the Inventory Specialist 530 will collect and document facts for subsequent submission to a Catalog Specialist. Other key responsibilities of Inventory Specialist 530 include: (a) attending client appointments, (b) collecting the facts including all photographs, measurements, notation of markings and distinguishing features, and condition description and (c) submitting the facts to the Catalog Specialist within assignment parameters.

FIG. 14c shows how an Inventory Specialist sets availability windows for appointments to conduct on-site inventory meetings. FIG. 14d shows how the Inventory Specialist may manage appointments and assignments. FIG. 14e shows how the Inventory Specialist may submit completed assignments as uploaded files, photo albums, or references in notes. FIG. 14f shows how the Inventory Specialist might be accountable for managing billable time practice management and health of community.

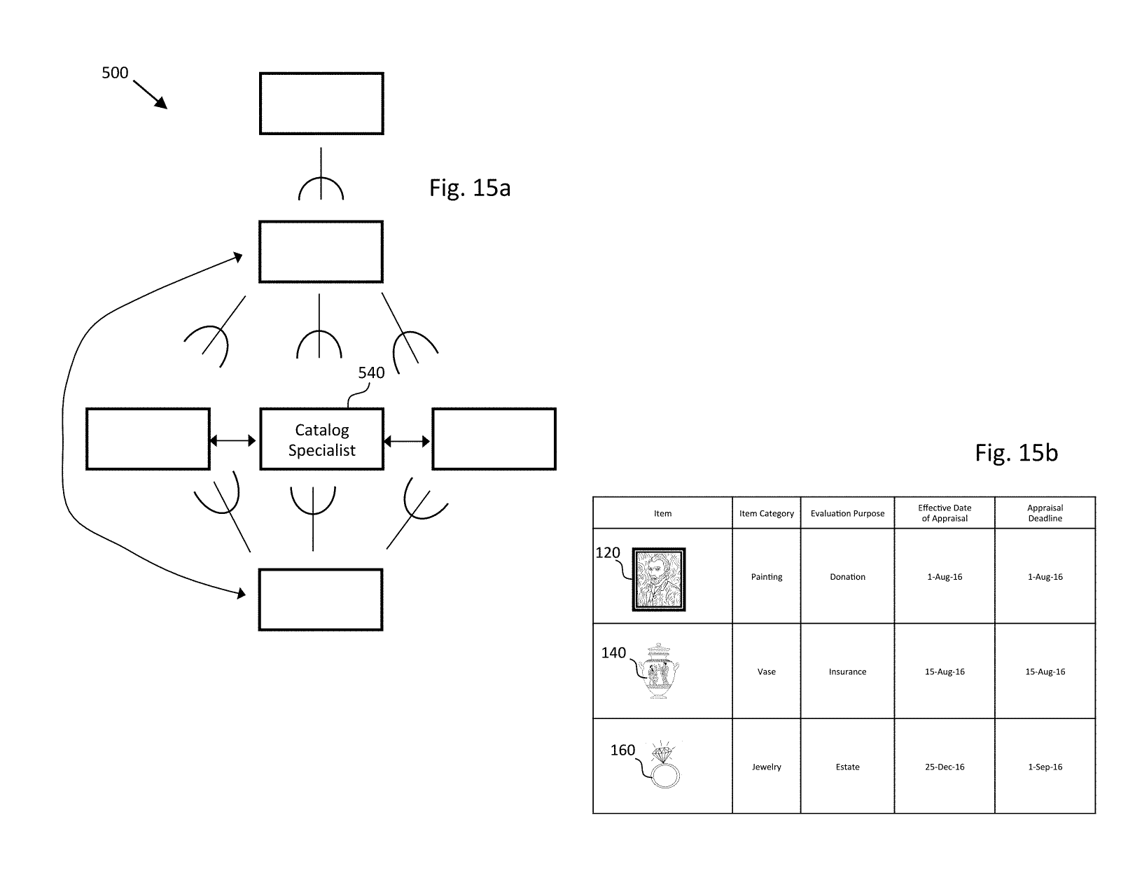

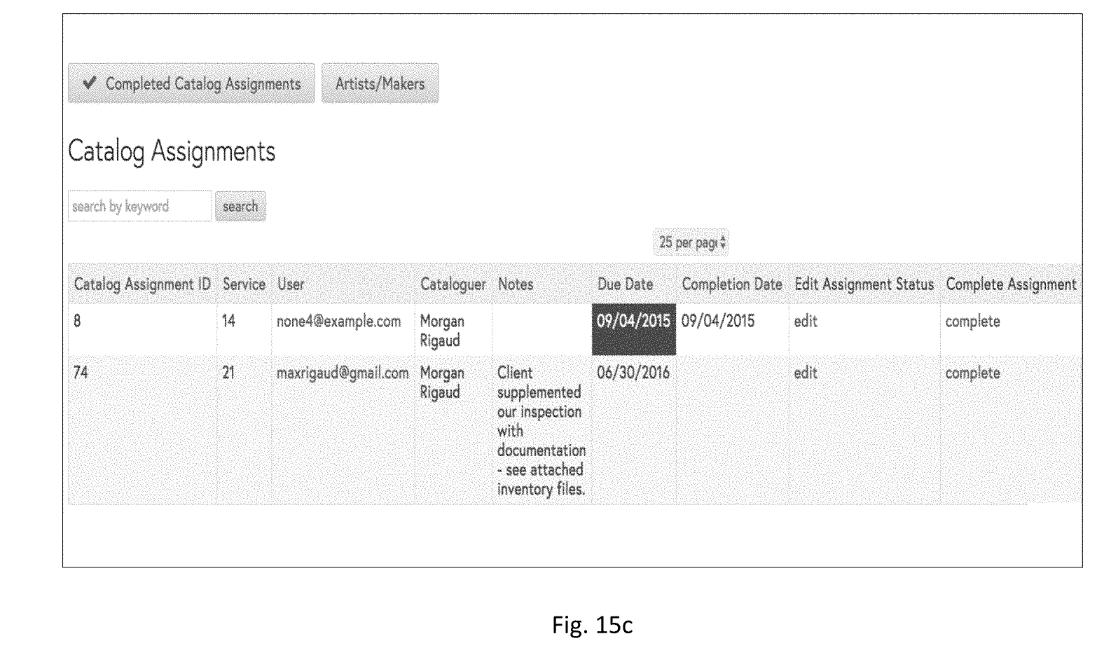

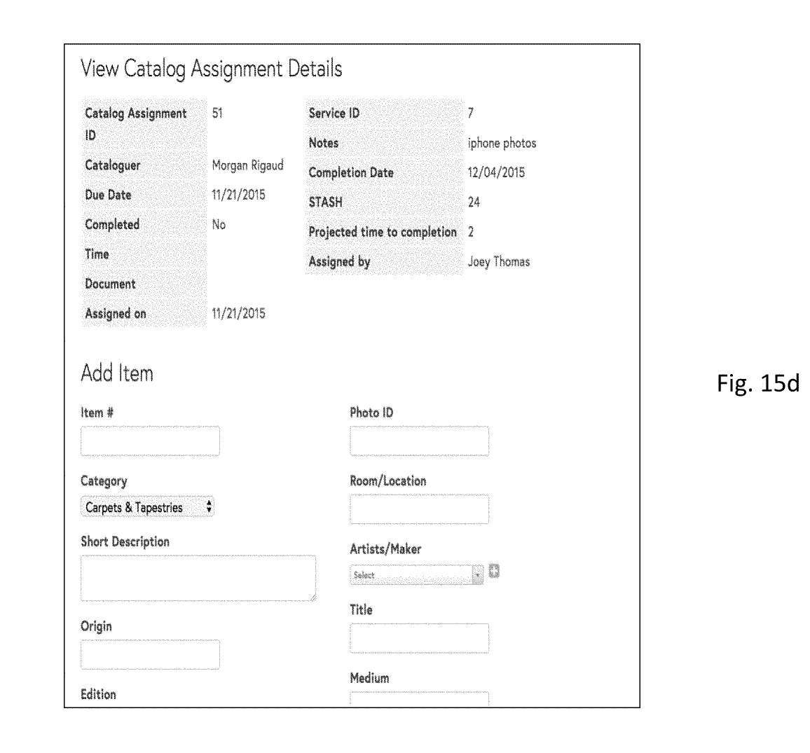

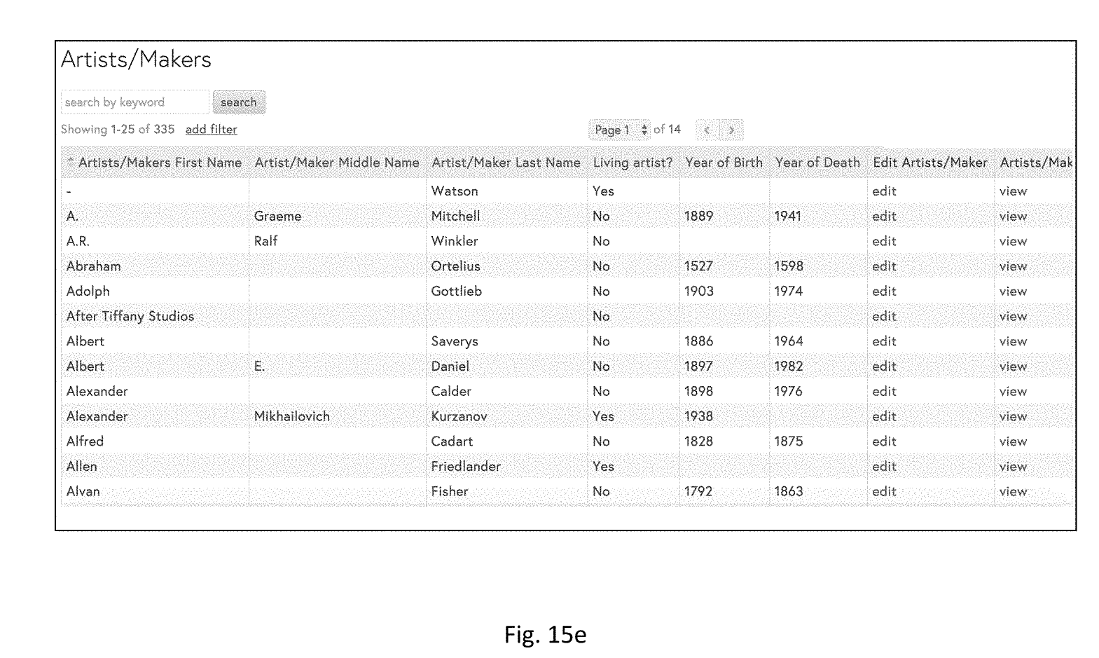

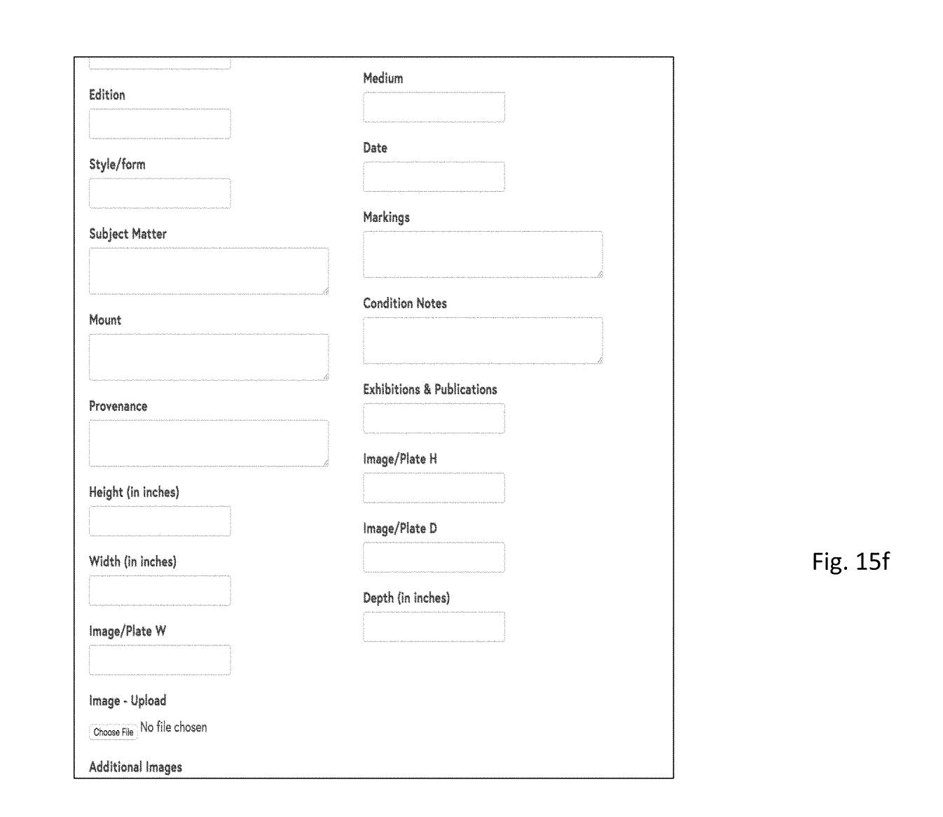

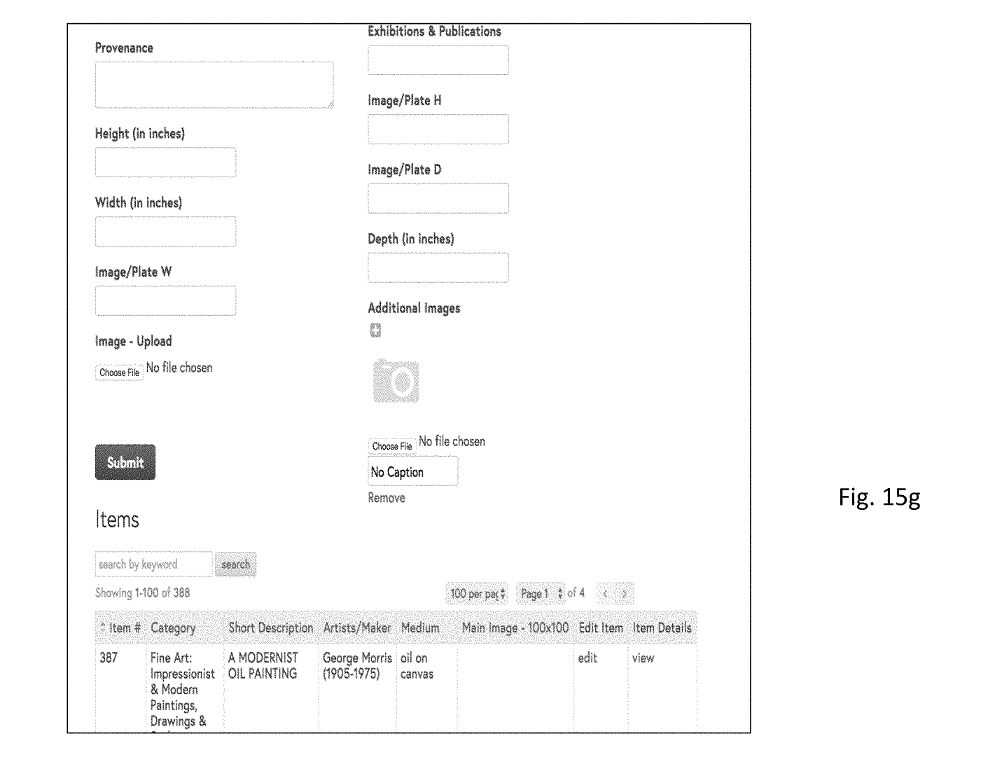

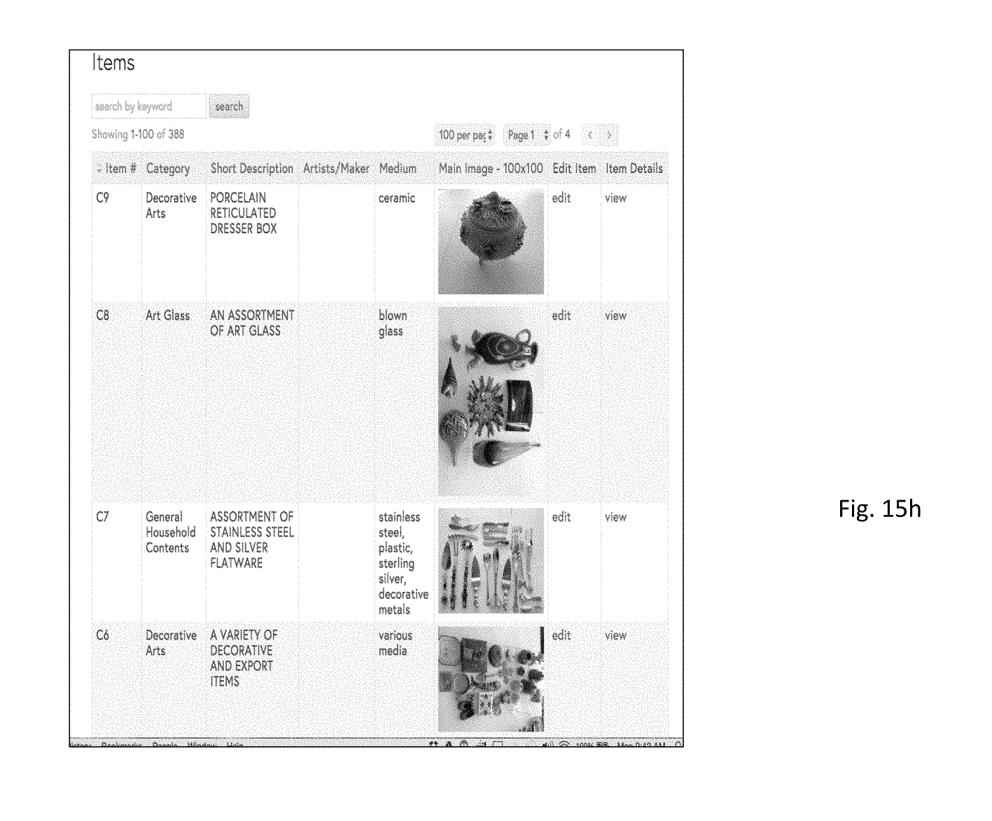

FIGS. 15a and 15b show a non-limiting, exemplary embodiment of an organizational model 500 wherein the Catalog Specialist 540 who validates the info provided by the Inventory Specialist and uses the facts to construct an itemized inventory catalog. The items are categorized based on their facts/attributes (e.g., object type, style, origin, age). Based on the service terms, the items are assigned to a qualified appraiser as a valuation assignment, or simply entered into the system for storage. FIG. 15c shows how the Catalog Specialist may manage assignments. FIG. 15d shows how the Catalog Specialist may complete assignments using the long form for each line item. FIG. 15e shows an exemplary listing of Artists/Makers and biographical information about each. FIGS. 15f-15g shows an exemplary set of characteristics used to catalog an item. FIG. 15h shows an exemplary screenshot illustrating a set of cataloged items that may be reviewed by a Catalog Specialist before finalizing the collection for subsequent appraisals.

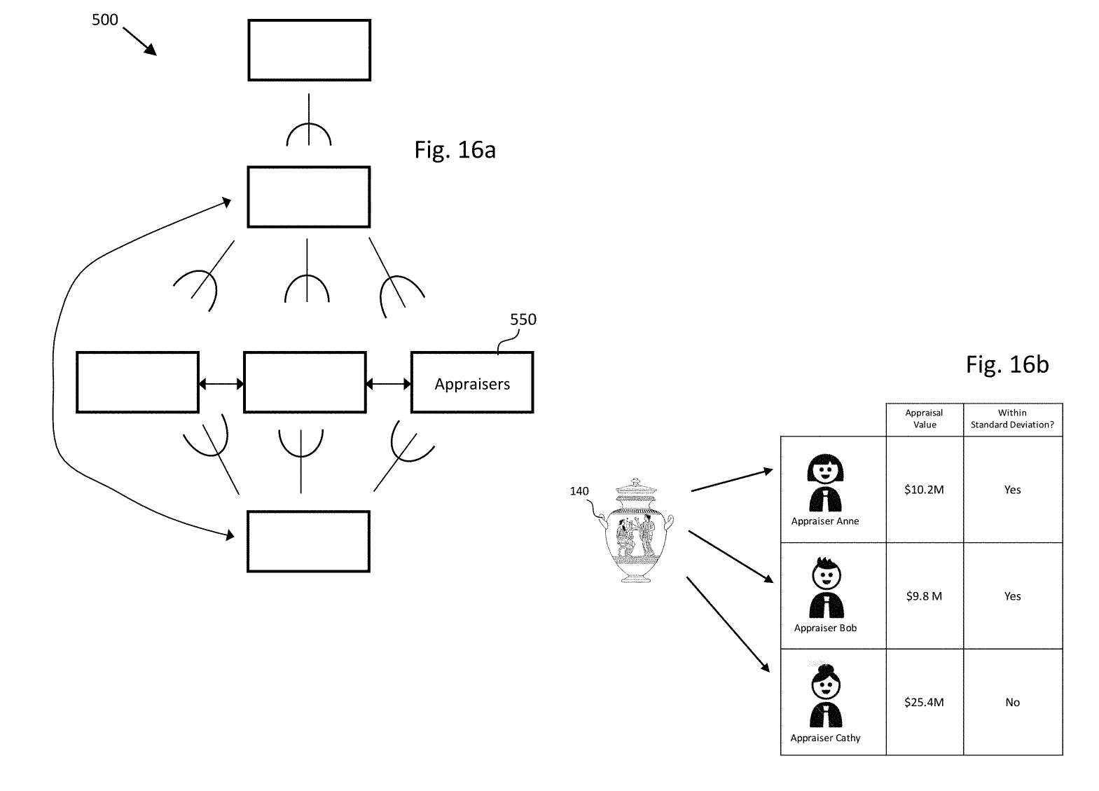

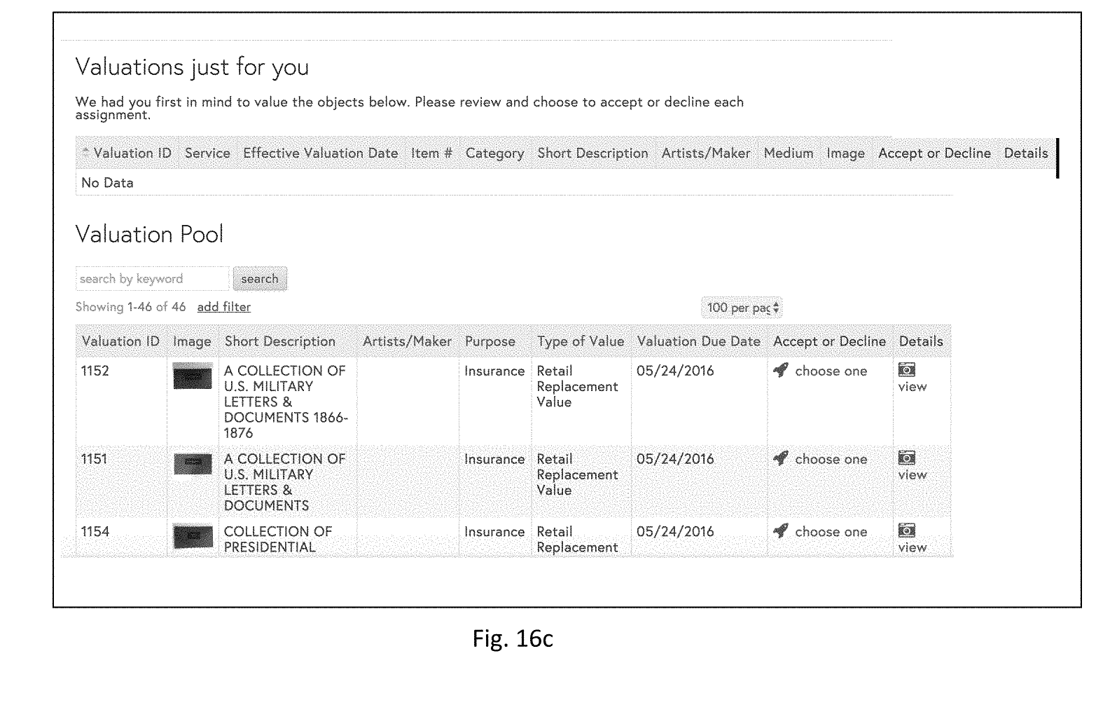

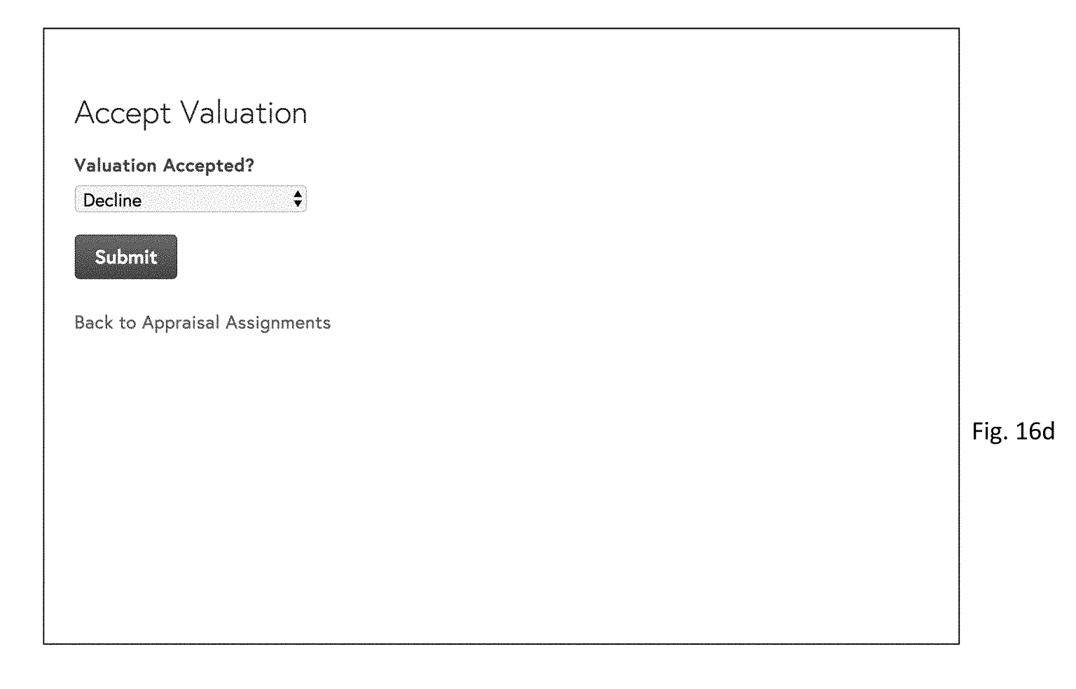

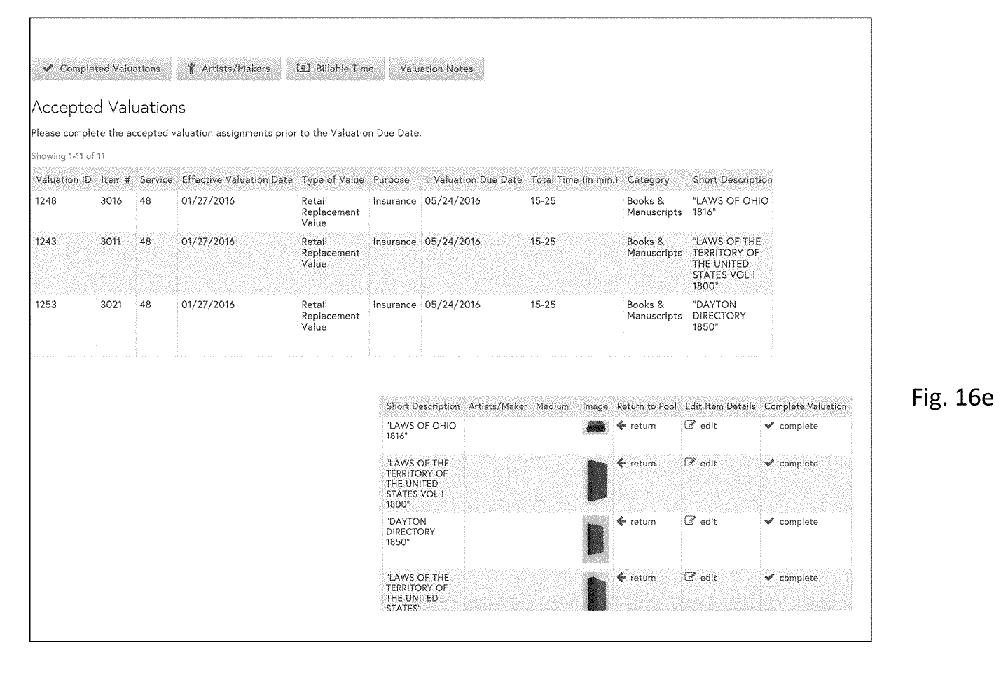

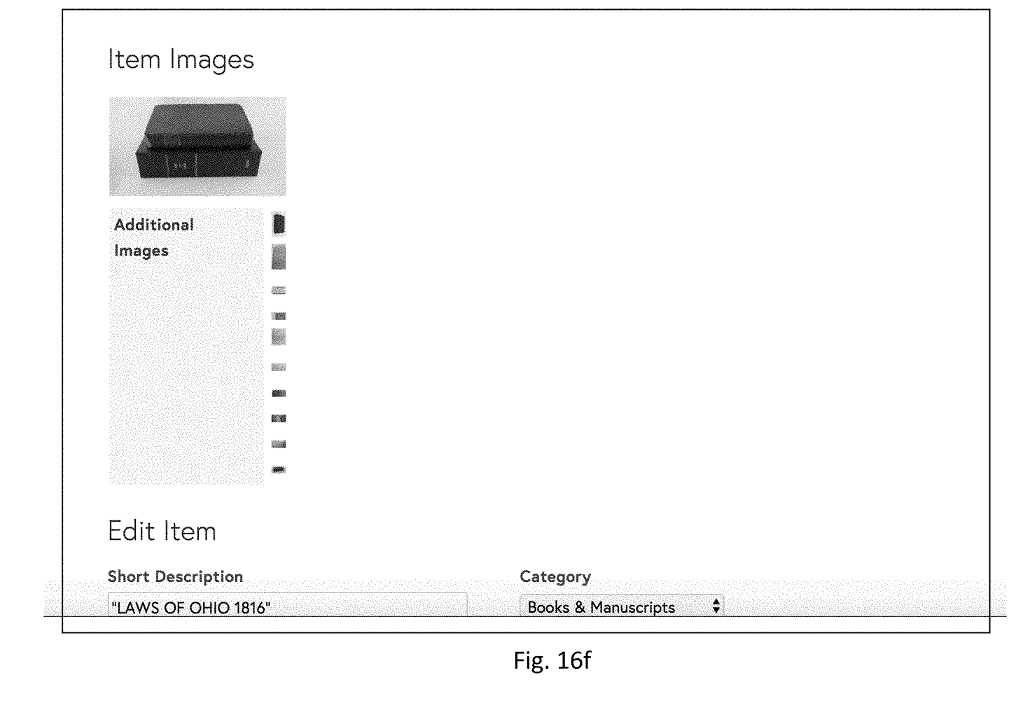

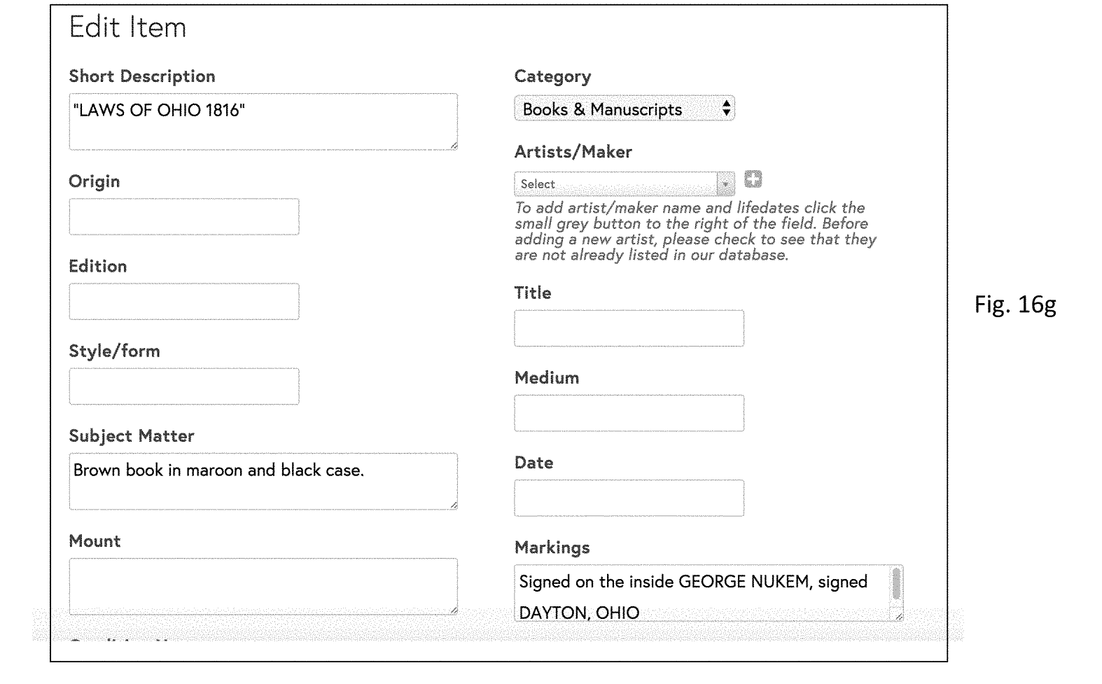

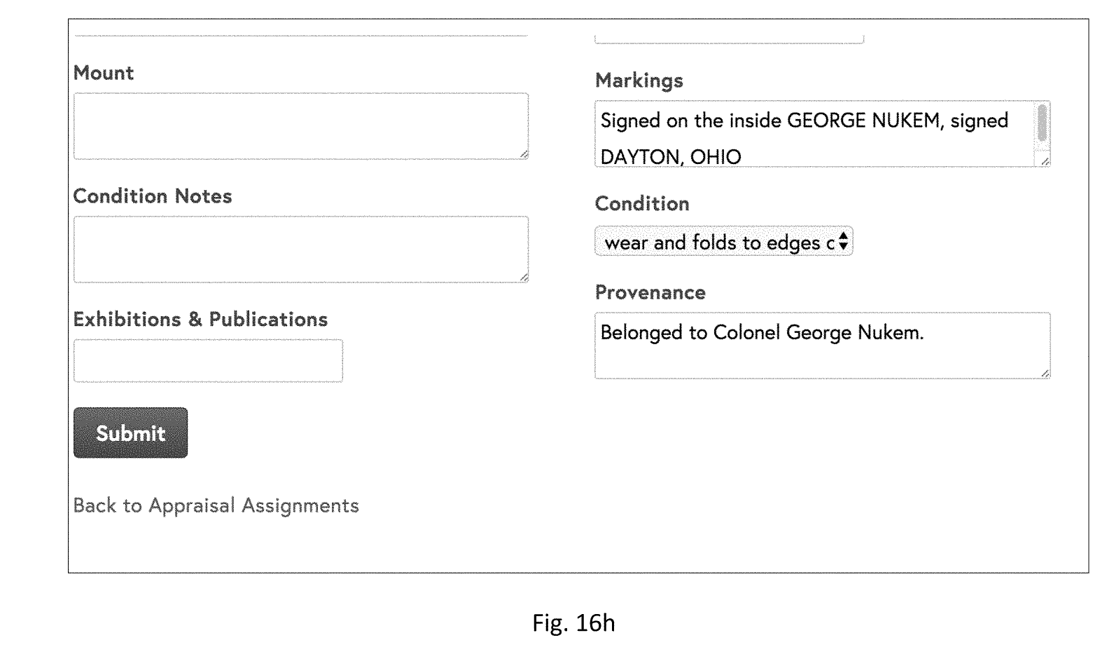

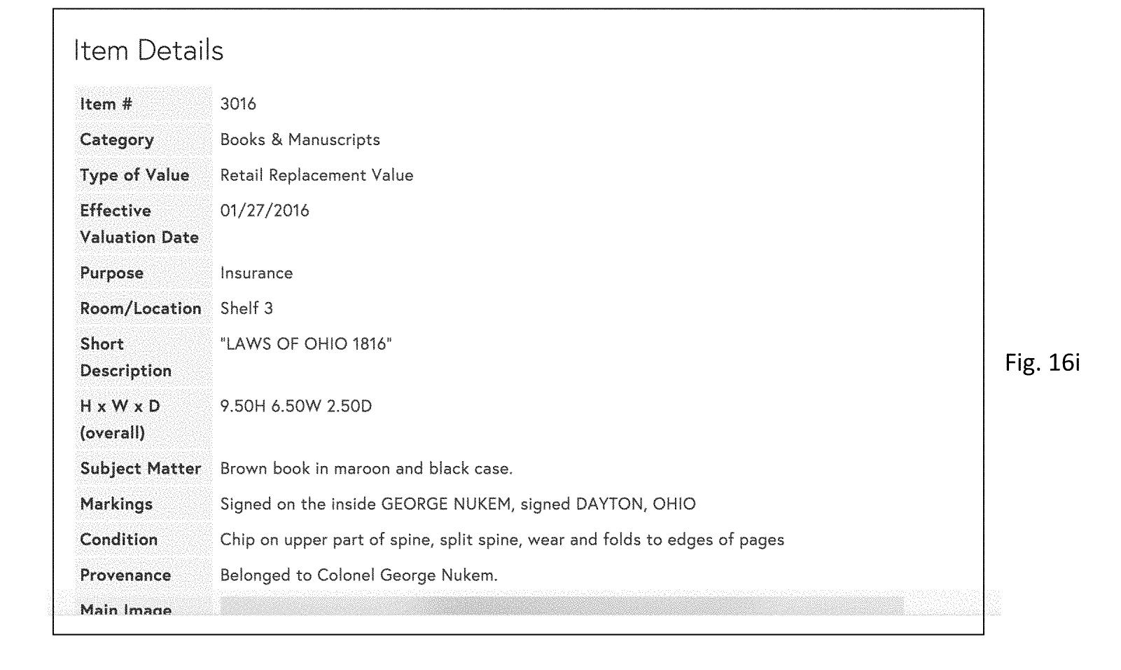

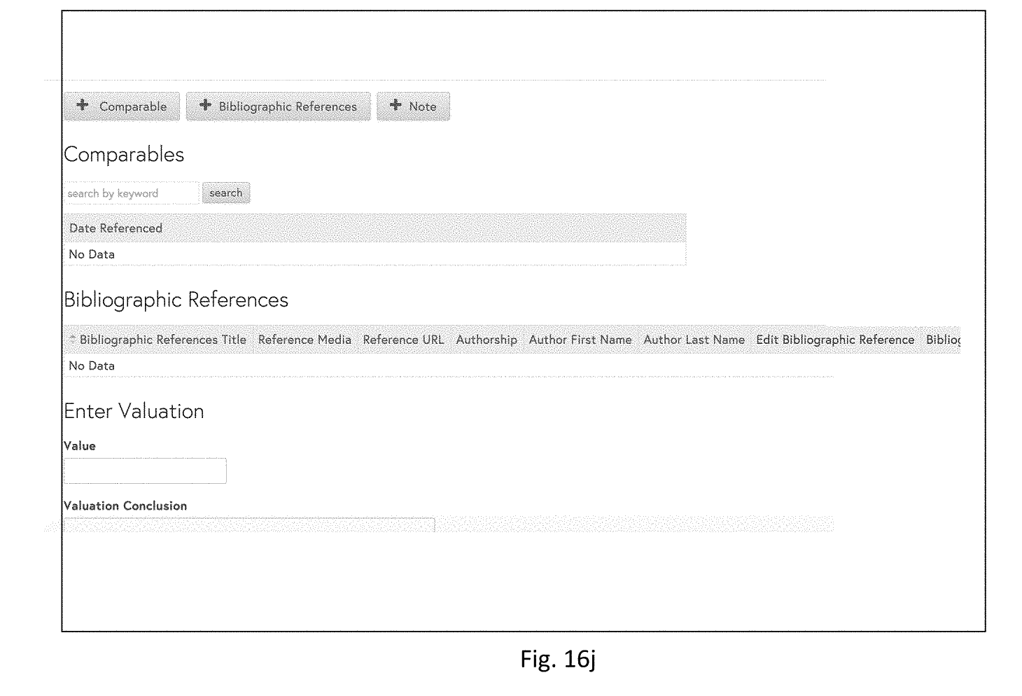

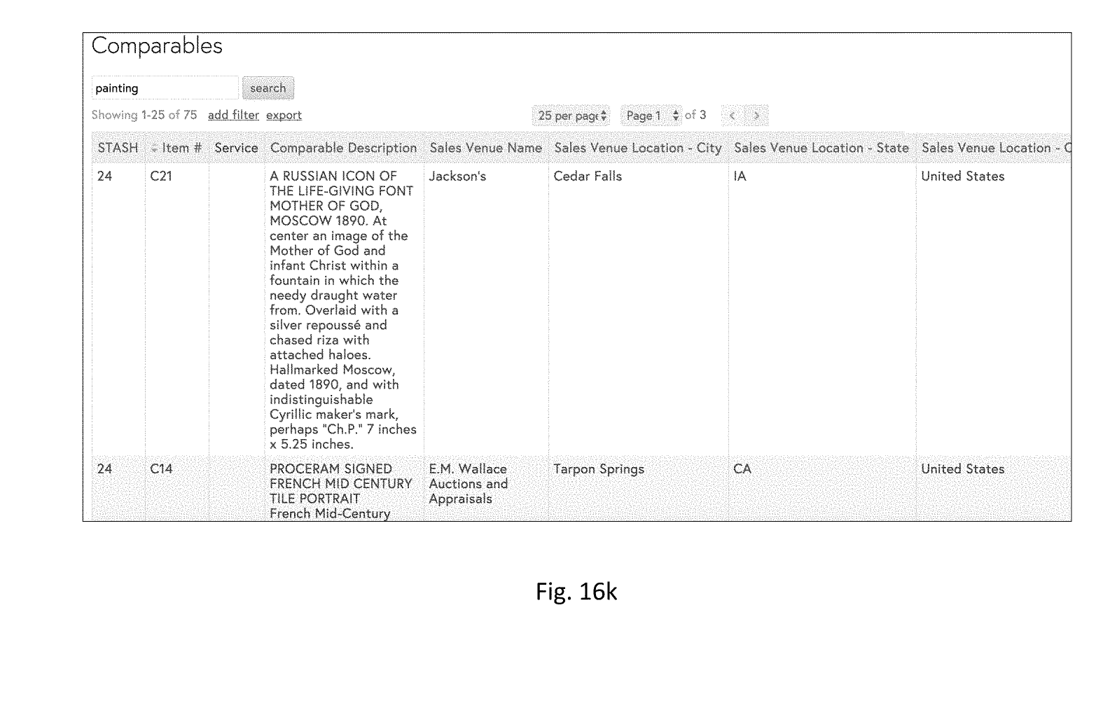

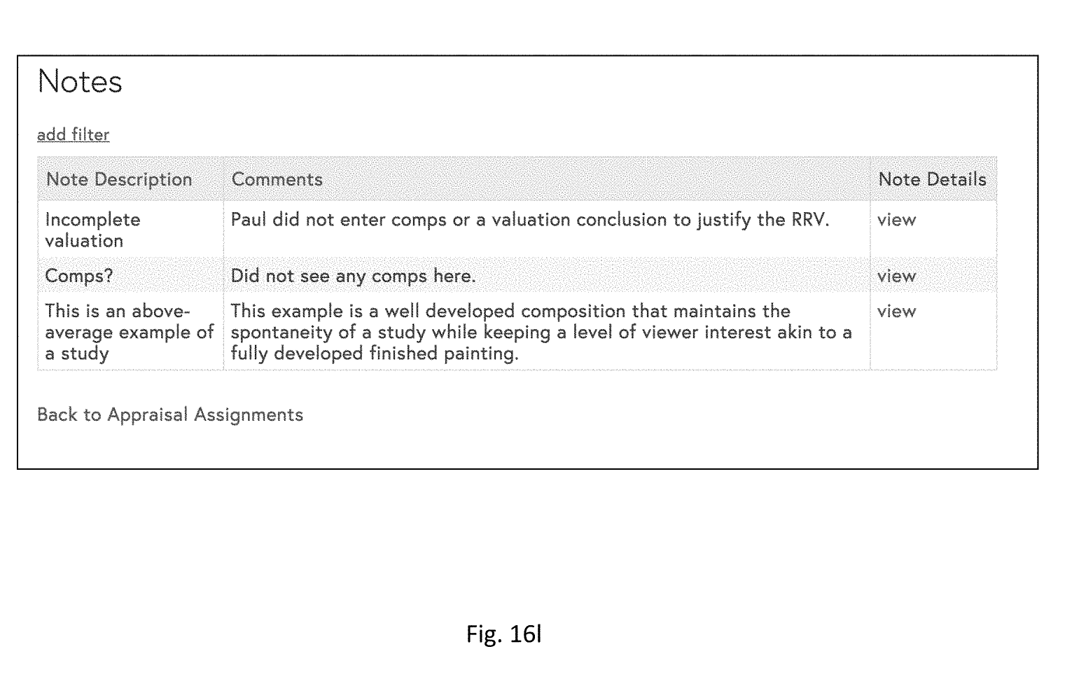

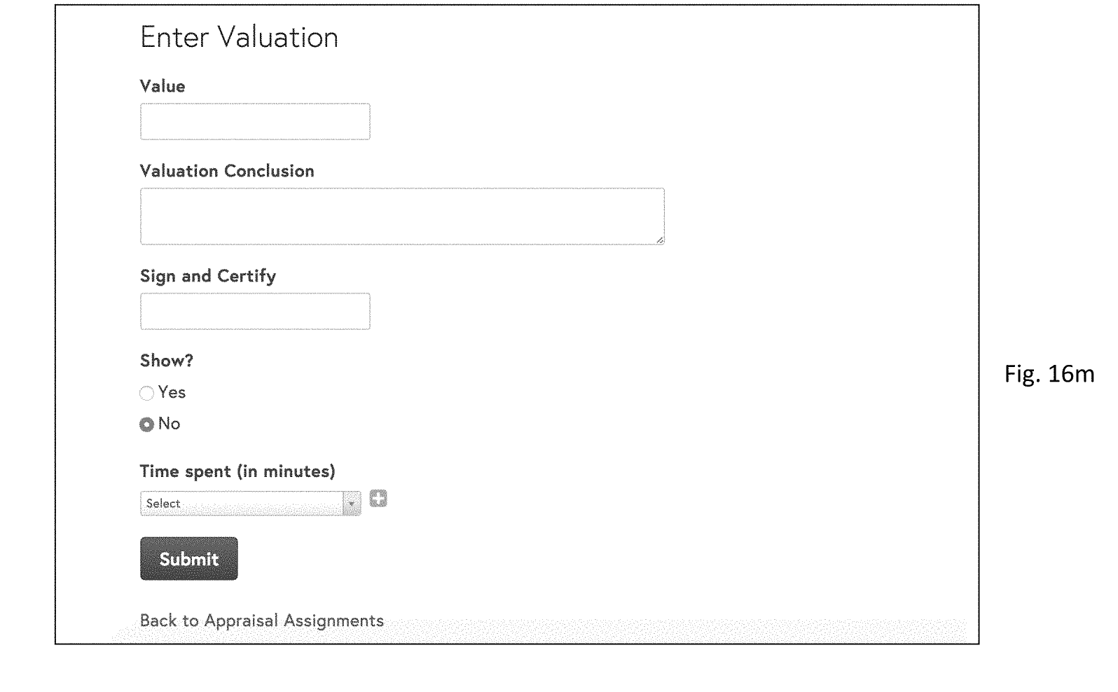

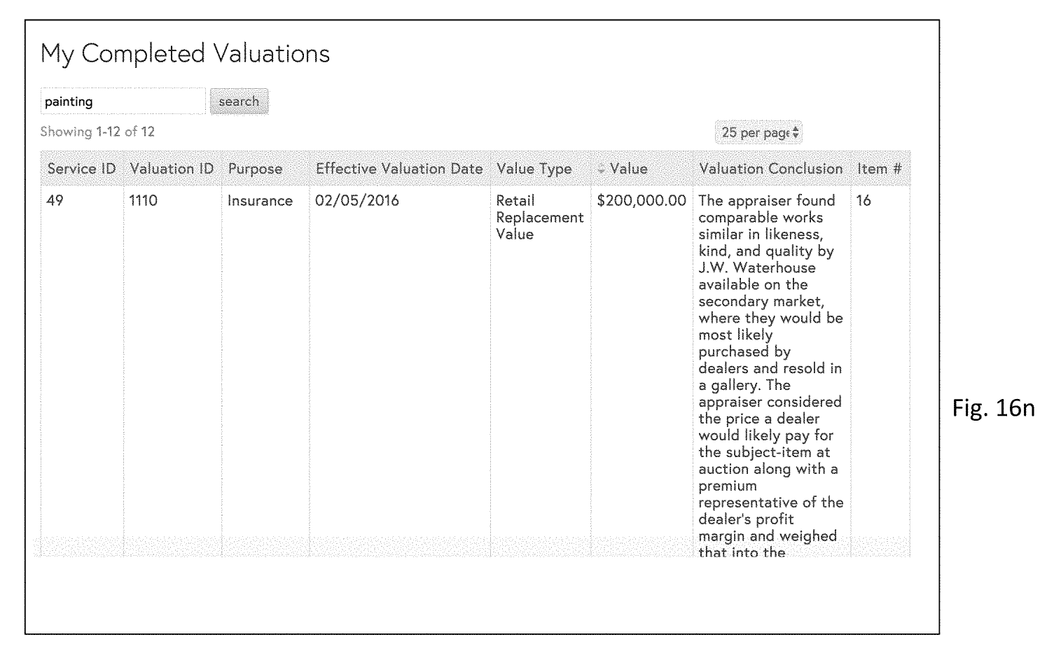

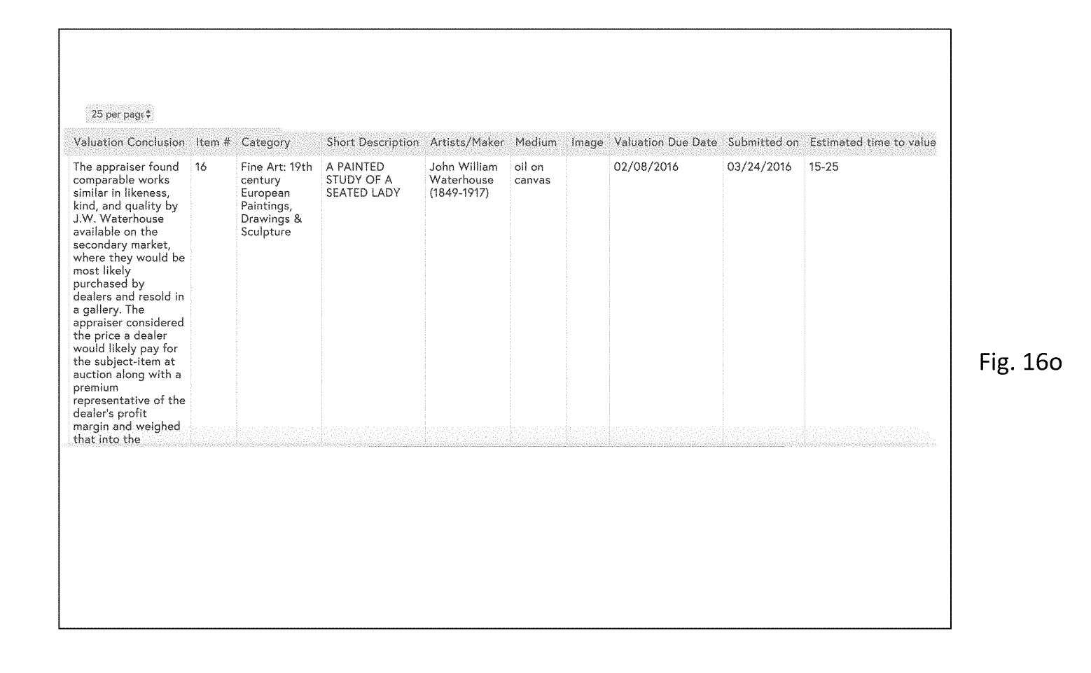

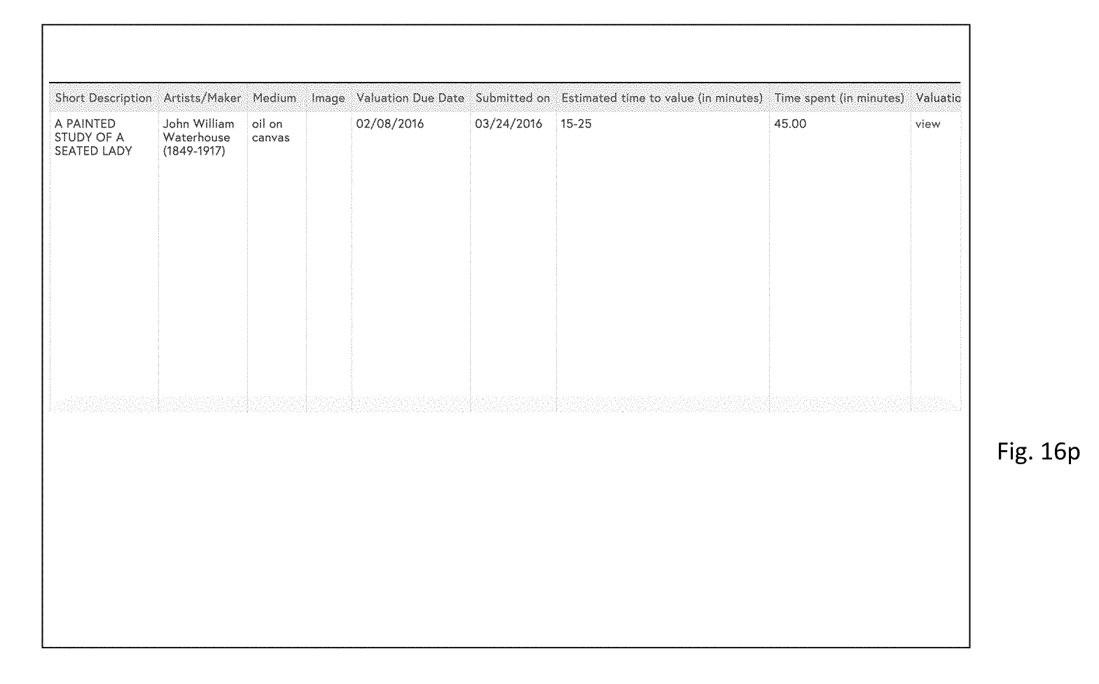

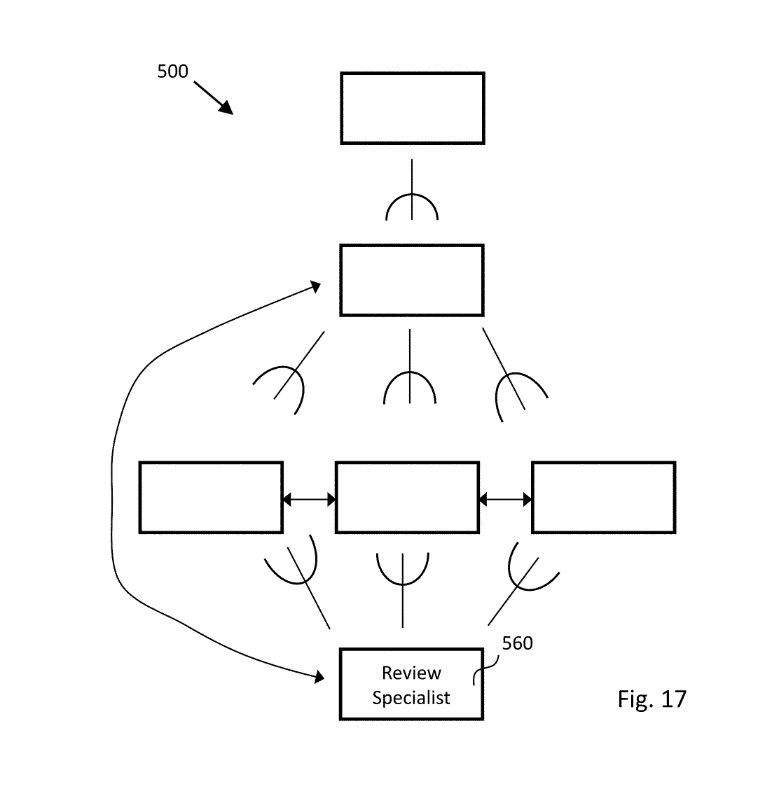

FIGS. 16a and 16b show a non-limiting, exemplary embodiment of an organizational model 500 wherein the Appraisers 550 will be selected for subsequent appraisal of a collection. FIG. 16b shows three appraisers each appraising the same high value item wherein one appraiser's valuation falls outside of the standard deviation and is therefore discarded. This aberration will also allow the system to disqualify Appraiser Cathy from future valuations for the ceramic vase category. FIG. 16c shows an exemplary screenshot illustrating a set of items that have been offered to one Appraiser for their possible acceptance for subsequent valuation. FIG. 16d shows an exemplary screenshot illustrating where an Appraiser declined an offered appraisal assignment. FIG. 16e shows an exemplary screenshot illustrating a set of accepted valuations that an Appraiser has accepted and completed. FIGS. 16f-16i show exemplary screenshots illustrating where an Appraiser has further described the item based on their own knowledge and discovery efforts, including collaborating with the network community peers. FIG. 16j-16k show exemplary screenshots illustrating where an Appraiser has identified comparable items that were considered when attempting to appraise the subject item. FIG. 16l shows an exemplary screenshot illustrating where an Appraiser has entered notes that may be useful to a variety of people (e.g., Project Coordinator, Managing Director, client). FIG. 16m shows an exemplary screenshot illustrating where an Appraiser has entered their appraised valuation for the item. FIG. 16n-16p show exemplary screenshots illustrating a table of completed valuations that were assigned to the Appraiser.

FIG. 17 shows a non-limiting, exemplary embodiment of an organizational model 500 wherein the Review Specialist 560 may review the final report of all the appraisal and related information. The Review Specialist 560 may review the final report before it is submitted to the client.

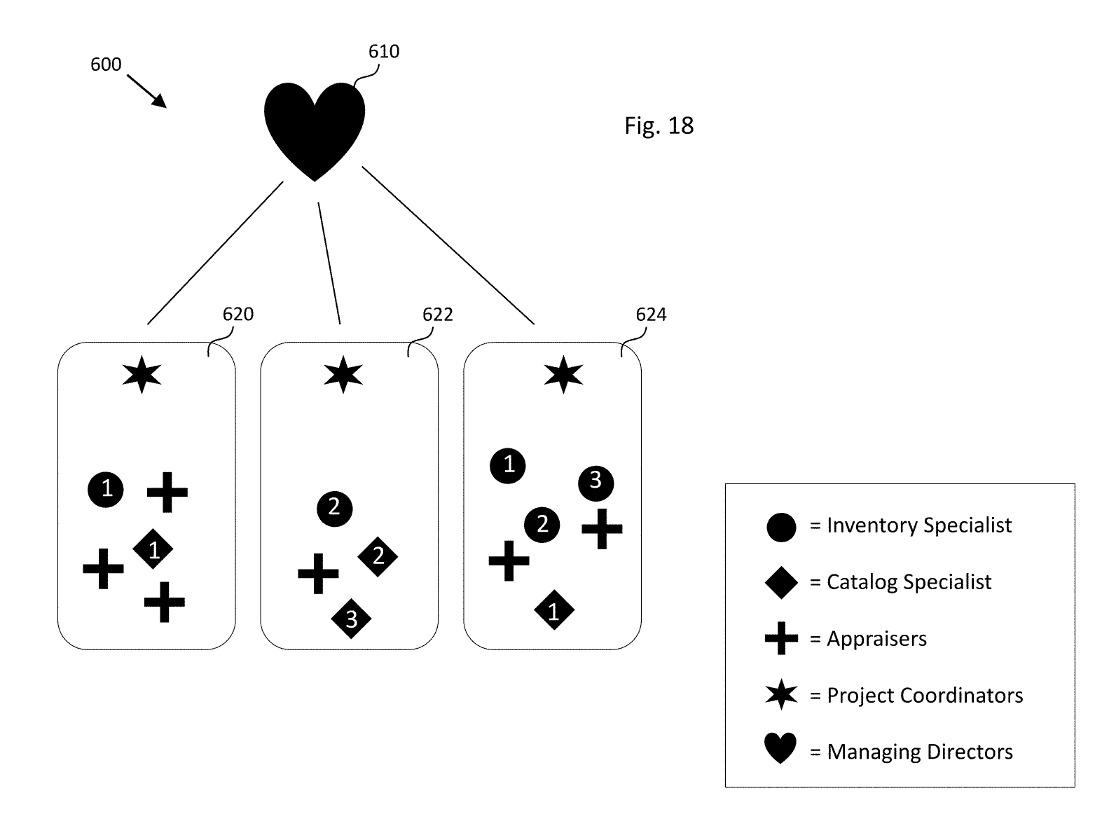

FIG. 18 shows a non-limiting, exemplary embodiment of an organizational model 600 to illustrate the fact that a customized team configuration may be established for a variety of TPP collections, 620, 622, 624. Said differently, while the roles and responsibilities above have been described in a exemplary manner, any such team composition may be configured to achieve the particular needs of a certain TPP collection.

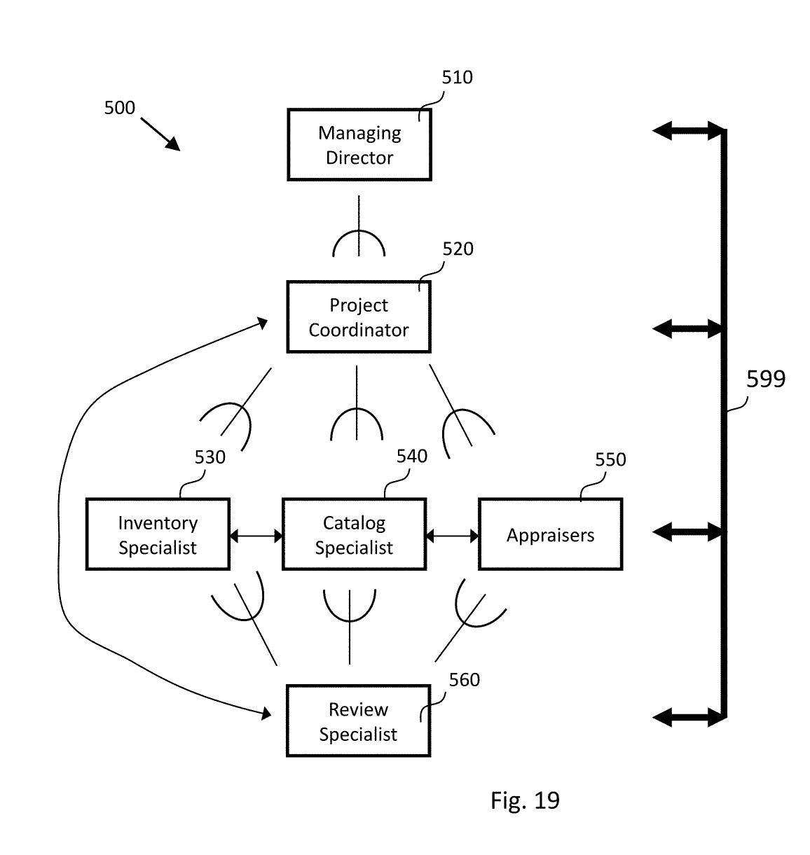

FIG. 19 shows a non-limiting, exemplary embodiment of a communication network 599 to illustrate the fact that the various resources/members of the network community find value in collaborating.

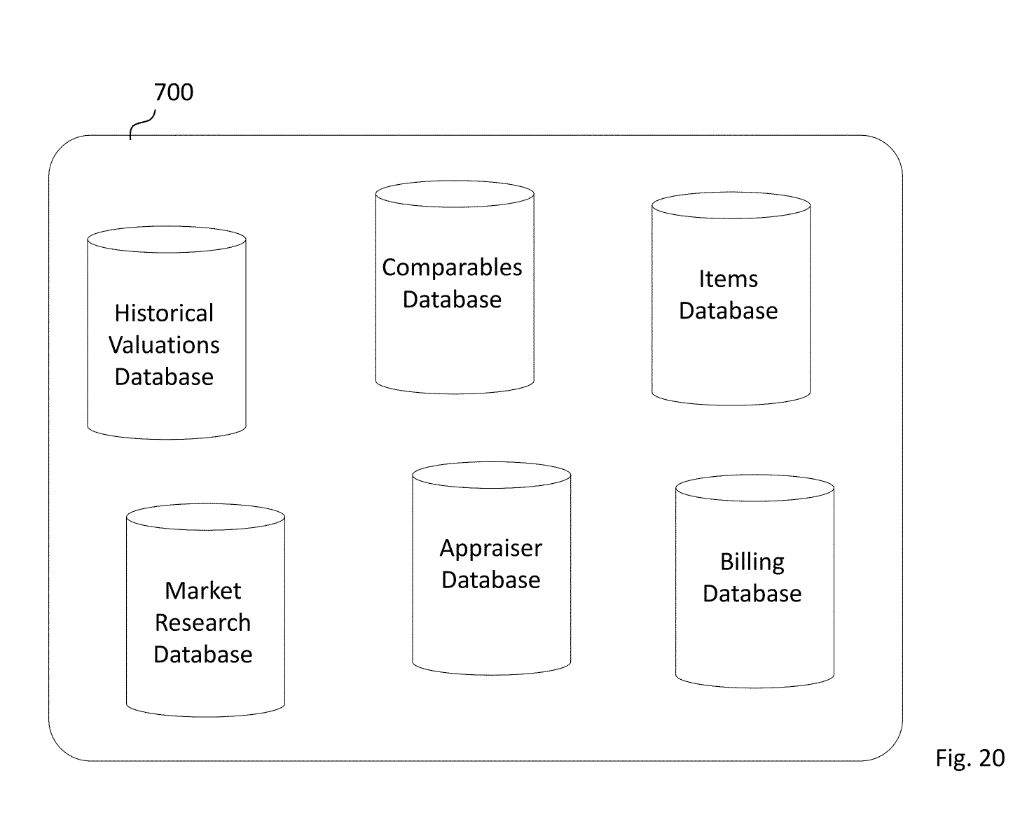

FIG. 20 shows a non-limiting, exemplary embodiment of a collection of databases 700 that comprise the various types of useful data that are useful to this present invention. While these exemplary databases are shown, one skilled in the art would appreciate other databases that would be beneficial in a network community and system described in the present invention.

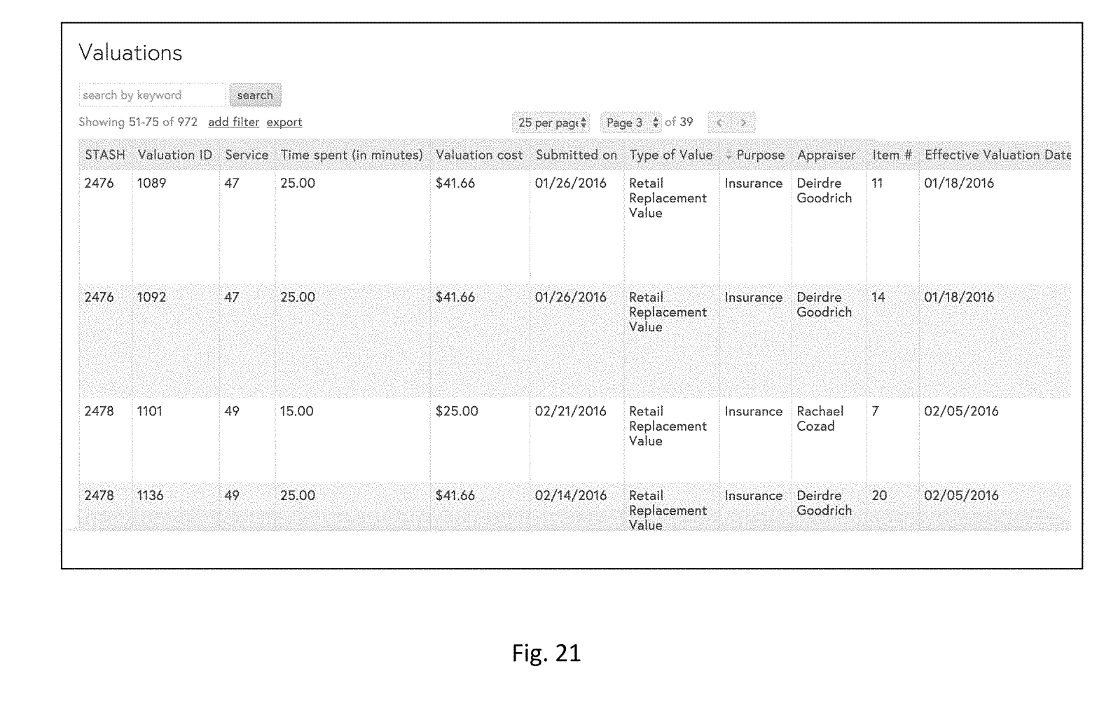

FIG. 21 shows an exemplary screenshot illustrating where a set of completed valuations performed by a variety of Appraisers across a variety of TPP collections (also referred to as Stashes). This exemplary screenshot may be particularly useful to a Project Coordinator or Managing Director as they seek to identify the status of various collections.

What is claimed is:

1. A method of valuating an item for a client, comprising the steps of:
(a) identifying the item-category of the item;
(b) identifying the valuation-purpose based on the client's needs;
(c) assigning an appraiser from a community of appraisers and
(d) valuating the item using the right valuation method for said valuation-purpose.

2. The method of claim 1, and having in (c), wherein said appraiser is qualified to valuate the item for the item-category and valuation-purpose.

3. The method of claim 1, and having in (c), wherein said appraiser is represented by two or more individual appraisers so as to competently appraise the item for the item-category and valuation-purpose.

4. The method of claim 1, and having in (c), wherein said assigning of an appraiser is performed by a project coordinator.

5. The method of claim 1, and having in (a), wherein said identifying of the item is performed by an inventory specialist.

6. The method of claim 1, and having in (a), including the identifying of item-category for a plurality of items.

7. The method of claim 6, and having in (a), wherein said plurality of items are grouped within a collection by a catalog specialist.

8. The method of claim 1, and having in (b), wherein said identifying of the valuation-purpose is performed by an inventory specialist or project coordinator.

9. The method of claim 1, and having in (b), including the identifying of valuation-purpose for a plurality of items.

10. The method of claim 1, and having in (d), including the assigning of an appropriate number of appraisers for the underlying valuation-purpose.

11. The method of claim 1, and having in (d), including the validating of a plurality of valuations by comparing them to each other.

12. The method of claim 1, further comprising the step of:
(e) preparing a valuation report for the client.

13. A method of valuating a plurality of items using a networked-community, comprising the steps of:
(a) assigning a first item for valuation to a first appraiser of an appraisal community, said appraisal community having a plurality of appraisers; and
(b) assigning a second item for valuation to a second appraiser of said appraisal community, wherein the first item and second items are part of a collection and thus the collection is valuated faster by leveraging a plurality of appraisers with a networked-community.

14. The method of claim 13, and having in (b), wherein said assigning of first item and second item is performed by a Project Coordinator.

15. The method of claim 13, further comprising the step of:
(c) collaborating between the first appraiser and second appraiser to create a synergistic effect resulting in a better valuation.

16. The method of claim 15, further comprising the step of:
(d) re-assigning the first item to a third appraiser of an appraisal community to ensure a timely and competent valuation of the first item.

17. A method of creating and self-validating a community of appraisers, comprising the steps of:
(a) pre-qualifying appraisers for item-categories and valuation-purposes;
(b) assessing the performance of said appraisers; and
(c) modifying the appraiser networked-community membership based on their performance.

18. The method of claim 17, and having in (b), wherein said assessing of appraisers is performed by their peers within the networked-community.

19. The method of claim 17, and having in (c), wherein said modifying the appraiser networked-community is performed by a managing director.

20. The method of claim 17, and having in (c), wherein said modifying is electronically automated.
